(19) United States
(12) Patent Application Publication
(10) Pub. No.: US 2012/0099561 A1
(43) Pub. Date: Apr. 26, 2012

(54) Handover Control Method and Device

(75) Inventors: Jie Zhao, Shenzhen (CN); Jixing Liu, Shenzhen (CN); Xiaobo Wu, Shanghai (CN)

(73) Assignee: HUAWEI TECHNOLOGIES CO., LTD., Shenzhen (CN)

(21) Appl. No.: 13/342,126

(22) Filed: Jan. 2, 2012

Related U.S. Application Data
(63) Continuation of application No. PCT/CN2010/074874, filed on Jul. 1, 2010.

(30) Foreign Application Priority Data
Jul. 1, 2009 (CN) 200910146764.0

(51) Int. Cl. H04W 36/00

(52) U.S. Cl. 370/331

(57) ABSTRACT

A handover control method is applicable to handover between networks adopting different access technologies. A serving gateway of a source network buffers downlink data of a user terminal on the source network after the source network determines that the user terminal is ready to be handed over to a target network. The serving gateway of the source network sends the downlink data to a serving gateway of the target network after the user terminal is handed over from the source network to the target network.

### CROSS-REFERENCE TO RELATED APPLICATIONS

This application is a continuation of International Application No. PCT/CN2010/074874, filed on Jul. 1, 2010, which claims priority to Chinese Patent Application No. 200910146764.0, filed on Jul. 1, 2009, all of which are hereby incorporated by reference in their entireties.

### FIELD OF THE INVENTION

The present invention relates to the field of communications technologies, and in particular, to a handover control method and a device.

### BACKGROUND OF THE INVENTION

With the development of communications technologies, many communication networks have been evolved continuously to provide a higher rate and more services, and interworking between different evolved networks may be achieved through relevant interfaces.

Referring to FIG. 1, FIG. 1 is a schematic architecture diagram of interworking between a Long Term Evolution (LTE) network and an evolved High Rate Packet Data (eHRPD) network. The LTE network mainly includes an evolved node B (eNB) 1101, a Mobility Management Entity (MME) 1102, and a Serving Gateway (S-GW) 1103, and the LTE network may further include a Home Subscriber Server (HSS) 1106, a Third Generation Partnership Project (3GPP) Authentication Authorization Accounting (AAA) server 1108, and a service network 1107. The eHRPD network mainly includes an evolved Access Network (eAN), a Packet Control Function (PCF) entity 1202, an HRPD Serving Gateway (HSGW) 1203, an access network authentication authorization accounting server (AN AAA server) 1204, and a 3GPP2 AAA server 1205. A Packet Data Network Gateway (P-GW) 1104 and a Policy and Charging Rules Function (PCRF) entity 1105 are shared by the LTE network and the eHRPD network.

As shown in FIG. 1, an interworking connection between the LTE network and the eHRPD network mainly includes that: the MME and the eAN are connected through an interface S101; the S-GW and the HSGW are connected through an interface S103-U; the P-GW and the HSGW are connected through an interface S2a; the PCRF entity and the HSGW are connected through an interface Gxa; and the 3GPP AAA Server and the 3GPP2 AAA Server are connected through an interface Sta.

A user equipment (UE) may perform data communication on the LTE network, and may also perform data communication on the eHRPD network. The UE may be handed over between the LTE network and the eHRPD network by adopting an optimized handover mode or a non-optimized handover mode. A network to which the UE is handed over may be called a target network, a network that the UE leaves may be called a source network, and the target network and the source network are defined relatively.

By taking an example that a UE is handed over from an LTE network to an eHRPD network by adopting non-optimized handover, in an existing handover procedure, the UE executes non-optimized handover, an air interface is handed over from the LTE network to the eHRPD network, while a relevant bearer of the UE on the LTE network is reserved. If the UE is in a connection state, and a P-GW obtains downlink data of the UE on the LTE network, the P-GW generally continuously sends the obtained downlink data of the UE on the LTE network to an S-GW. The S-GW generally forwards the downlink data of the UE on the LTE network, where the downlink data of the UE on the LTE network is obtained from the P-GW, to an eNB. The eNB generally directly discards the downlink data of the UE on the LTE network, where the downlink data of the UE on the LTE network is obtained from the S-GW, after failing to send the downlink data of the UE on the LTE network. After being handed over to the eHRPD network, the UE cannot obtain the downlink data on the LTE network.

### SUMMARY OF THE INVENTION

According to one aspect, the present invention provides a handover control method, which is used for handover between networks adopting different access technologies, where the method includes: buffering, by a serving gateway of a source network, downlink data of a user terminal on the source network after acquiring, by the source network, that the user terminal is ready to be handed over to a target network; and after the user terminal is handed over from the source network to the target network, sending, by the serving gateway of the source network, the downlink data to a serving gateway of the target network.

According to another aspect, the present invention provides a handover control method, which is used for handover between networks adopting different access technologies, where the method includes: after receiving a notification for buffering data, where the notification for buffering data is from a source network, buffering, by a data gateway, downlink data of a user terminal on the source network; and after the user terminal is handed over from the source network to a target network; and sending, by the data gateway, the buffered downlink data to a serving gateway of the target network. The method further includes: acquiring, by the source network, that the user terminal is ready to be handed over to the target network.

According to another aspect, the present invention further provides a serving gateway, including: a buffering module, configured to, after acquiring that a user terminal is ready to be handed over to a target network, buffer downlink data of the user terminal on a source network; and a sending module, configured to, send the downlink data buffered by the buffering module to a serving gateway of the target network after the user terminal is handed over from the source network to the target network.

According to another aspect, the present invention provides a data gateway, including: a buffering module, configured to, after acquiring that a user terminal is ready to be handed over to a target network, buffer downlink data of the user terminal on a source network; and a sending module, configured to, after the user terminal is handed over to the target network, send the downlink data buffered by the buffering module to a serving gateway of the target network.

It can be seen from the foregoing technical solutions that: the technical solutions according to the embodiments of the present invention have the following advantages: After acquiring that the UE is ready to be handed over from the source network to the target network, the downlink data of the UE on the source network is buffered, and the buffered downlink data of the UE on the source network is sent to the serving gateway of the target network, so that the UE that is handed over to the target network can obtain the downlink data of the UE on the source network from the serving gateway of the target network, thus preventing the UE from losing the downlink data of the UE on the source network.

### BRIEF DESCRIPTION OF THE DRAWINGS

In order to illustrate the technical solutions according to the embodiments of the present invention and in the prior art more clearly, accompanying drawings required for describing the embodiments and the prior art are briefly introduced below. Apparently, the accompanying drawings in the following description are only some embodiments of the present invention, and persons of ordinary skill in the art may further obtain other drawings from these accompanying drawings without creative efforts.

FIG. 1 is a schematic architecture diagram of interworking between an LTE network and an eHRPD network;

FIG. 2 is a flowchart of a handover control method according to an embodiment of the present invention;

FIG. 3 is a flowchart of a handover control method according to a first embodiment of the present invention;

FIG. 4 is a flowchart of a handover control method according to a second embodiment of the present invention;

FIG. 5 is a flowchart of a handover control method according to a third embodiment of the present invention;

FIG. 6 is a flowchart of a handover control method according to a fourth embodiment of the present invention;

FIG. 7 is a flowchart of a handover control method according to a fifth embodiment of the present invention;

FIG. 8 is a flowchart of a handover control method according to a sixth embodiment of the present invention;

FIG. 9 is a flowchart of a handover control method according to a seventh embodiment of the present invention;

FIG. 10 is a flowchart of a handover control method according to an eighth embodiment of the present invention;

FIG. 11 is a flowchart of a handover control method according to a ninth embodiment of the present invention;

FIG. 12 is a flowchart of a handover control method according to a tenth embodiment of the present invention;

FIG. 13 is a flowchart of a handover control method according to an eleventh embodiment of the present invention;

FIG. 14 is a schematic structural diagram of a serving gateway according to a twelfth embodiment of the present invention;

FIG. 15 is a schematic structural diagram of a data gateway according to a thirteenth embodiment of the present invention;

FIG. 16 is a schematic structural diagram of a mobility management entity according to a fourteenth embodiment of the present invention;

FIG. 17 is a schematic structural diagram of a serving gateway according to a fifteenth embodiment of the present invention;

FIG. 18 is a schematic structural diagram of an access network device according to a sixteenth embodiment of the present invention;

FIG. 19 is a schematic structural diagram of an access network device according to a seventeenth embodiment of the present invention; and

FIG. 20 is a schematic structural diagram of a user equipment according to an eighteenth embodiment of the present invention.

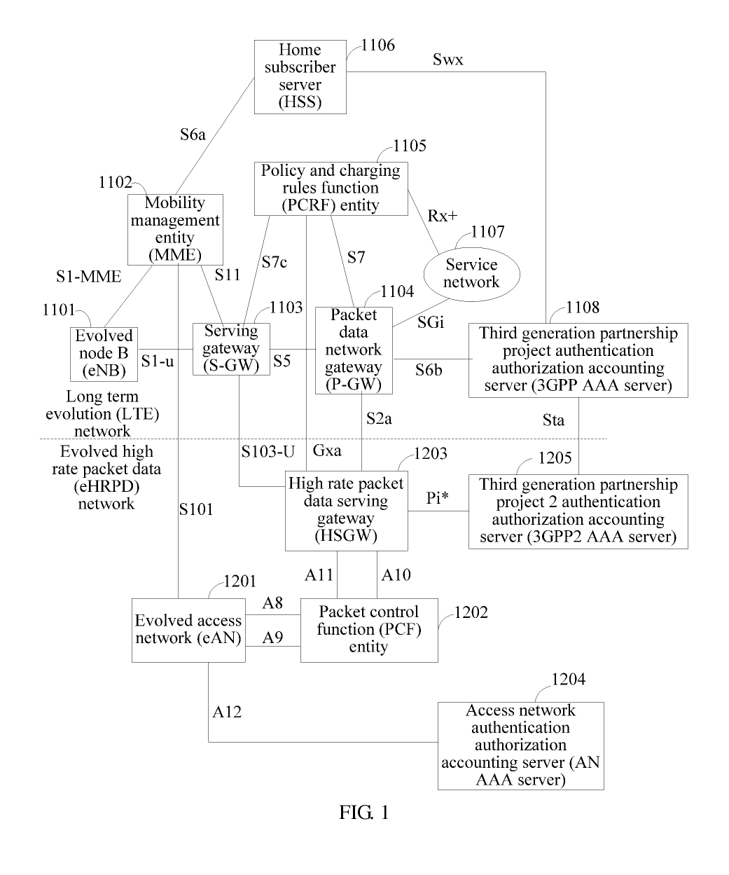

### DETAILED DESCRIPTION OF THE EMBODIMENTS

Embodiments of the present invention provides a handover control method and a device, which can prevent a UE that is handed over to a target network from losing downlink data of the UE on a source network.

The present invention is described in detail below respectively through specific embodiments.

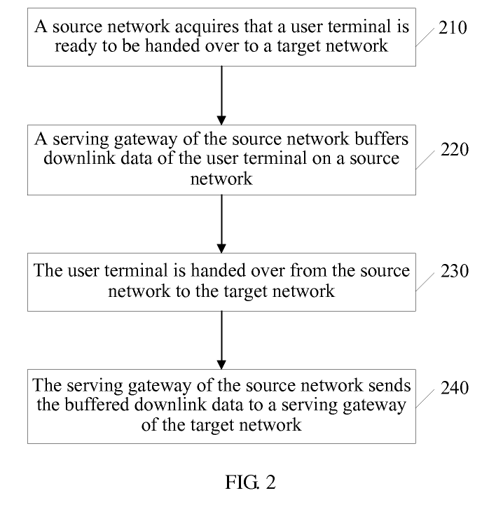

Referring to FIG. 2, a handover control method according to an embodiment of the present invention may include the following content.

210: A source network acquires that a user terminal is ready to be handed over to a target network.

In an application scenario, the source network may acquire that the user terminal is ready to be handed over from a source network to a target network through many manners.

For example, a UE (in the embodiment of the present invention, the UE is an example of the user terminal) or an access network device may notify a core network device of the source network that the UE is ready to be handed over from the source network to the target network.

220: A serving gateway of the source network buffers downlink data of the user terminal on the source network.

In an application scenario, after acquiring that the UE is ready to be handed over from the source network to the target network, the serving gateway of the source network may begin to buffer the downlink data of the UE on the source network.

230: The user terminal is handed over from the source network to the target network.

240: The serving gateway of the source network sends the downlink data to a serving gateway of the target network.

In an application scenario, the serving gateway of the source network may establish a data forwarding tunnel between the serving gateway of the source network and the serving gateway of the target network, and send the downlink data to the serving gateway of the target network through the established data forwarding tunnel; the serving gateway of the source network may also forward the downlink data to the serving gateway of the target network through a data gateway.

The source network and the target network may be networks adopting different access technologies.

After the UE is handed over to the target network, the UE may obtain the downlink data of the UE on the source network from the serving gateway of the target network.

The technical solution according to the embodiment of the present invention may be applicable to handover between an LTE network and an eHRPD network, or may be applicable to handover between other networks adopting different access technologies, which is not limited here.

In an application scenario, the source network is an LTE network, the target network is an eHRPD network, the serving gateway of the source network may be an S-GW, the serving gateway of the target network may be an HSGW, and the data gateway may be a P-GW.

In another application scenario, the source network is an eHRPD network, the target network is an LTE network, the serving gateway of the source network may be an HSGW, the serving gateway of the target network may be an S-GW, and the data gateway may be a P-GW.

It can be seen from the foregoing technical solution that, in the embodiment of the present invention, after that the UE is ready to be handed over from the source network to the target network is acquired, the downlink data of the UE on the source network is buffered, and the downlink data of the UE on the source network is sent to the serving gateway of the target network, so that the UE that is handed over to the target network can obtain the downlink data of the UE on the source network from the serving gateway of the target network, thus preventing the UE from losing the downlink data of the UE on the source network.

For convenience of understanding the technical solution according to the embodiment of the present invention, an example that an LTE network is the source network, an eHRPD network is the target network, a UE is handed over from the LTE network to the eHRPD network, an S-GW is responsible for buffering the downlink data of the UE on the LTE network, an HSGW obtains an IP address of the S-GW from a P-GW, and triggers establishment of a data forwarding tunnel between the HSGW and the S-GW is taken for specific description.

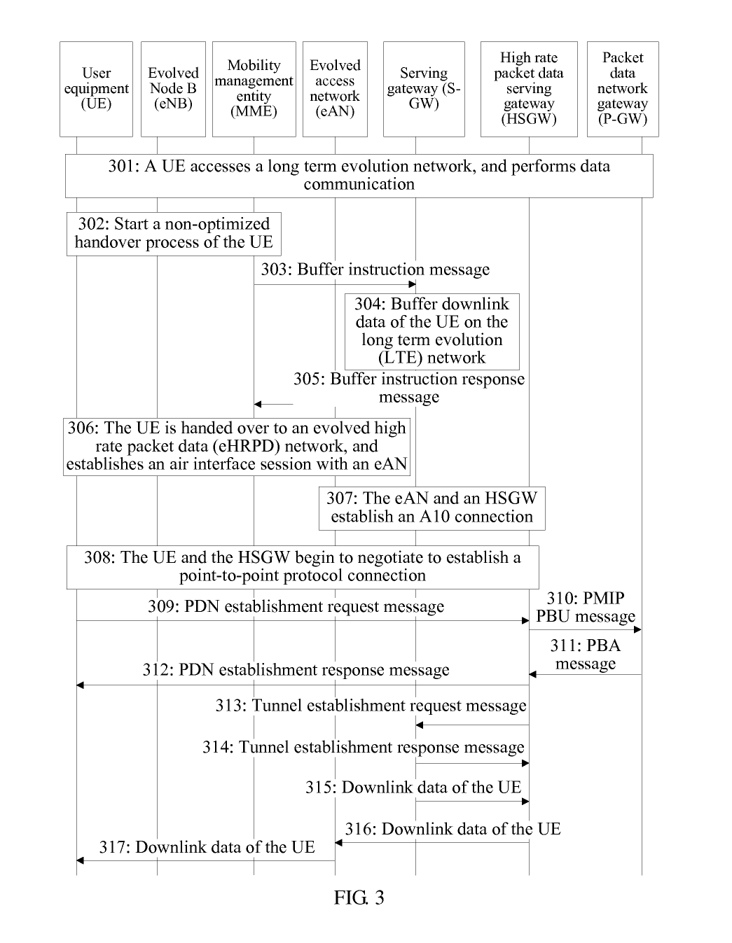

Referring to FIG. 3, a handover control method according to a first embodiment of the present invention may include the following content.

301: A UE accesses an LTE network.

In an application scenario, the UE currently accesses an LTE network, and the UE that accesses the LTE network may perform data communication with a service network or other user equipment.

302: Start a non-optimized handover process of the UE.

In an application scenario, if a signal of the LTE network is weakened, when it is detected that a signal of an eHRPD network is stronger than the signal of the LTE network, or due to other reasons, a network side or the UE may start the non-optimized handover process of the UE.

In an application scenario, starting the non-optimized handover process of the UE may adopt one of the following three methods, to which the present invention is not limited.

### Method 1

A11: A UE sends a handover notification message to an MME.

In an application scenario, if the UE is ready to be handed over to an eHRPD network, the UE may send a handover notification message to the MME, where the handover notification message may carry information that the UE is ready to be handed over to the eHRPD network, and certainly may further carry other information.

The type of the handover notification message may be Non-Access Stratum (NAS) signaling, which can be transparently transferred from the UE to the MME. The UE may notify, by using the handover notification message, the MME that the UE is ready to be handed over to the eHRPD network.

In an application scenario, the handover notification message sent to the MME by the UE may specifically be: a detach request message, an attach request message, a Tracking Area Update (TAU) message, a service request message or other NAS signaling, which is not limited in the present invention.

A12: The MME sends a handover notification response message to the UE.

In an application scenario, after receiving the handover notification message sent by the UE, the MME acquires that the UE is ready to be handed over to the eHRPD network.

The MME may further send the handover notification response message to the UE.

In an application scenario, the handover notification response message sent to the UE by the MME may specifically be: a response message for the detach request (for example, detach accept), an attach accept/reject message, a TAU accept message, a service accept message, or other NAS signaling, which is not limited in the present invention.

### Method 2

B11: A UE sends a handover notification message to an eNB.

In an application scenario, if the UE is ready to be handed over to an eHRPD network, the UE may send a handover notification message to the eNB, where the handover notification message may carry indication information that the UE is ready to be handed over to the eHRPD network, and certainly may further carry other information.

The type of the handover notification message may be Access Stratum (AS) signaling. The UE may notify, by using the handover notification message, the eNB that the UE is ready to be handed over to the eHRPD network.

In an application scenario, the handover notification message sent to the eNB by the UE may be: an RRC Connection Release Request message or other AS signaling, which is not limited in the present invention.

B12: The eNB sends a handover notification message to an MME.

In an application scenario, after receiving the handover notification message sent by the UE, the eNB acquires that the UE is ready to be handed over to the eHRPD network.

The eNB may send a handover notification message to the MME, where the handover notification message may carry information that the UE is ready to be handed over to the eHRPD network, and certainly may further carry other information. The eNB notifies, by using the handover notification message, the MME that the UE is ready to be handed over to the eHRPD network.

In an application scenario, the handover notification message sent to the MME by the eNB may specifically be: an S1-AP UE context release request message, an S1-AP UE context modification request message, or other messages, which is not limited in the present invention.

B13: The MME sends a handover notification response message to the eNB.

In an application scenario, after receiving the handover notification message sent by the eNB, the MME acquires that the UE is ready to be handed over to the eHRPD network.

The MME may further send a handover notification response message to the eNB.

B14: The eNB sends a handover notification response message to the UE.

In an application scenario, after receiving the handover notification message sent by the UE, the eNB acquires that the UE is ready to be handed over to the eHRPD network. The eNB may further send a handover notification response message to the UE.

### Method 3

C11: An eNB sends a handover instruction message to a UE.

In an application scenario, a network side may directly decide that the UE executes non-optimized handover after the UE fails to execute pre-registration of optimized handover or in other cases.

The eNB may send a handover instruction message to the UE, where the handover instruction message may carry information instructing the UE to be handed over to the eHRPD network, and certainly may further carry other information.

The eNB may instruct, by using the handover instruction message, the UE to begin to execute non-optimized handover.

In an application scenario, the handover instruction message sent to the UE by the eNB may specifically be: an RRC connection release message or other AS signaling, which is not limited in the present invention.

C12: The eNB sends a handover notification message to an MME.

In an application scenario, after a network side decides that the UE executes non-optimized handover, the eNB may send a handover notification message to the MME, where the handover notification message may carry information that the UE is ready to be handed over to the eHRPD network, and certainly may further carry other information.

The eNB notifies, by using the handover notification message, the MME that UE is ready to be handed over to the eHRPD network.

In an application scenario, the handover notification message send to the MME by the eNB may specifically be: an S1-AP UE context release request message, an S1-AP UE context modification request message, or other messages, which is not limited in the present invention.

C23: The UE sends a handover instruction response message to the eNB.

In an application scenario, after receiving the handover instruction message sent by the eNB, the UE begins to execute a non-optimized handover process, and is ready to be handed over to the eHRPD network.

The UE may further send a handover instruction response message to the eNB.

C24: The MME sends a handover notification response message to the eNB.

In an application scenario, after receiving the handover notification message sent by the eNB, the MME acquires that the UE is ready to be handed over to the LTE network.

The MME may further send a handover notification response message to the eNB.

It can be seen that, through execution of one of the foregoing three operation methods, the MME can acquire that the UE is ready to be handed over to the eHRPD network, so as to further execute handover related processing.

303: The MME sends a buffer instruction message to an S-GW.

In an application scenario, after receiving the handover notification message sent by the UE or the eNB, the MME acquires that the UE is ready to be handed over to the eHRPD network, and the MME may send a buffer instruction message to the S-GW, where the buffer instruction message may carry instruction information instructing that it begins to buffer the downlink data of the UE on the LTE network, and certainly may further carry other information.

The MME may instruct, by using the buffer instruction message, the S-GW to begin to buffer the downlink data of the UE on the LTE network, where the downlink data of the UE on the LTE network is received from the P-GW.

In an application scenario, the buffer instruction message sent to the S-GW by the MME may specifically be: an update bearer request or other messages, which is not limited in the present invention.

304: The S-GW buffers the downlink data of the UE on the LTE network, where the downlink data of the UE on the LTE network is received from the P-GW.

In an application scenario, after receiving the buffer instruction message of the MME, the S-GW acknowledges that the UE is ready to be handed over from the LTE network to the eHRPD network, and begins to buffer the downlink data of the UE on the LTE network, where the downlink data of the UE on the LTE network is received from the P-GW.

Further, if the UE is in an activated state, the S-GW does not send the received downlink data of the UE on the LTE network to the eNB at this time; and if the UE is in an idle state, after receiving the downlink data of the UE on the LTE network, the S-GW does not trigger a process for paging a UE, so as to save network resources.

305: The S-GW sends a buffer instruction response message to the MME.

In an application scenario, after receiving the buffer instruction message sent by the MME, the S-GW may further send a buffer instruction response message to the MME.

In an application scenario, the buffer instruction response message sent to the MME by the S-GW may specifically be: an update bearer response or other messages, which is not limited in the present invention.

306: The UE is handed over to the eHRPD network, and establishes an air interface session with an eAN.

In an application scenario, if before being handed over to the eHRPD network, the UE has no air interface session on the eHRPD network, after being handed over to the eHRPD network, the UE establishes an air interface session with the eAN.

307: The eAN and an HSGW establish an A10 connection.

308: The UE and the HSGW begin to negotiate to establish a PPP connection.

In an application scenario, after the eAN and the HSGW establish the A10 connection, the UE begins to negotiate with the HSGW to establish a PPP connection, and begins to establish the PPP connection.

309: The UE sends a PDN establishment request message to the HSGW.

In an application scenario, the UE may initiate a process for establishing a PDN connection, and the UE may send a PDN establishment request message to the HSGW to request to establish the PDN connection.

In an application scenario, the PDN establishment request message sent to the HSGW by the UE may specifically be: a Vendor-Specific Network Control Protocol (VSNCP) configuration request message or other messages, which is not limited in the present invention.

310: The HSGW sends a PMIP Proxy Binding Update (PBU) message to the P-GW.

In an application scenario, after receiving the PDN establishment request sent by the UE, the HSGW may send a PMIP PBU message to a corresponding P-GW to request to establish a data bearer between the P-GW and the HSGW.

311: The P-GW sends a Proxy binding Acknowledge (PBA) message to the HSGW.

In an application scenario, after receiving the PMIP PBU message sent by the HSGW, the P-GW may establish the data bearer between the P-GW and the HSGW.

The P-GW sends a PBA message to the HSGW, where the PBA message may carry an IP address of the S-GW, and certainly may further carry other information.

312: The HSGW sends a PDN establishment request message to the UE.

In an application scenario, after receiving the PBA message sent by the P-GW, the HSGW may store information such as the IP address of the S-GW, where the IP address of the S-GW is carried in the PBA message.

The HSGW may further send a PDN establishment response message to the UE to notify the UE that a PDN connection is successfully established.

In an application scenario, the PDN establishment response message sent to the UE by the HSGW may specifically be: a VSNCP configuration response message or other messages, which is not limited in the present invention.

313: The HSGW sends a tunnel establishment request message to the S-GW.

In an application scenario, after obtaining the IP address of the S-GW, the HSGW may send a tunnel establishment request message to the S-GW to request to establish a data forwarding tunnel between the S-GW and the HSGW, so as to request to obtain the downlink data of the UE on the LTE network, where the downlink data of the UE on the LTE network is buffered by the S-GW. The tunnel establishment request message carries a parameter required for establishing a tunnel.

By taking an example that the HSGW requests to establish a Generic Routing Encapsulation (GRE) tunnel, the tunnel establishment request message may carry a tunnel establishment parameter required for establishing a data forwarding tunnel between the S-GW and the HSGW, and the tunnel establishment parameter may include the IP address of the HSGW, and may further include other parameters such as a GRE key and an Access Point Name (APN).

In an application scenario, the tunnel establishment request message may specifically be a PBU message.

Further, if the UE has multiple PDN connections on the LTE network, the HSGW may request to respectively establish an independent data forwarding tunnel for each PDN connection of the UE on the LTE network. Each GRE key corresponds to one PDN connection, and the APN is used to identify the PDN connections.

314: The S-GW sends a tunnel establishment response message to the HSGW.

In an application scenario, after receiving the tunnel establishment request message sent by the HSGW, the S-GW may store the tunnel establishment parameter carried in the tunnel establishment message.

The S-GW may establish the data forwarding tunnel between the S-GW and the HSGW by using the obtained tunnel establishment parameter. The S-GW may further send a tunnel establishment response message to the HSGW.

Further, if the UE has multiple PDN connections on the LTE network, the S-GW may respectively establish an independent data forwarding tunnel for each PDN connection of the UE on the LTE network.

In an application scenario, the tunnel establishment response message may specifically be a PBA message.

315: The S-GW sends the downlink data of the UE on the LTE network to the HSGW.

In an application scenario, if the S-GW buffers the downlink data of the UE on the LTE network, the S-GW may send the buffered downlink data of the UE on the LTE network to the HSGW through the data forwarding tunnel established between the S-GW and the HSGW.

If multiple data forwarding tunnels are established for the corresponding multiple PDN connections between the S-GW and the HSGW, the S-GW may respectively send, through multiple data forwarding tunnels, to the HSGW downlink data of the UE on the LTE network, where the downlink data of the UE on the LTE network corresponds to the multiple PDN connections.

316: The HSGW further sends to the eAN the downlink data of the UE on the LTE network, where the downlink data of the UE on the LTE network is obtained by the HSGW from the S-GW.

317: The eAN further sends to the UE the downlink data of the UE on the LTE network, where the downlink data of the UE on the LTE network is obtained by the eAN from the HSGW.

In an application scenario, the UE that is handed over to the eHRPD network receives the downlink data of the UE on the LTE network, where the downlink data of the UE on the LTE network is sent by the eAN.

It should be noted that, the foregoing actions are described as a series of steps for convenience of description, and part of the steps have no certain precedence order.

It can be seen from the foregoing technical solution that, after the UE is ready to be handed over from the LTE network to the eHRPD network, the S-GW of the LTE network buffers the downlink data of the UE on the LTE network, the S-GW sends the buffered downlink data of the UE on the LTE network to the HSGW of the eHRPD network, so that the UE that is handed over to the eHRPD network can obtain the downlink data of the UE on the LTE network from the HSGW, thus preventing the UE from losing the downlink data of the UE on the LTE network.

In the following, an example that an LTE network is the source network, an eHRPD network is the target network, a UE is handed over from the LTE network to the eHRPD network, an S-GW is responsible for buffering the downlink data of the UE on the LTE network, the S-GW obtains an IP address of an HSGW from a P-GW, and the S-GW directly sends the downlink data of the UE on the LTE network to the HSGW is taken for specific description.

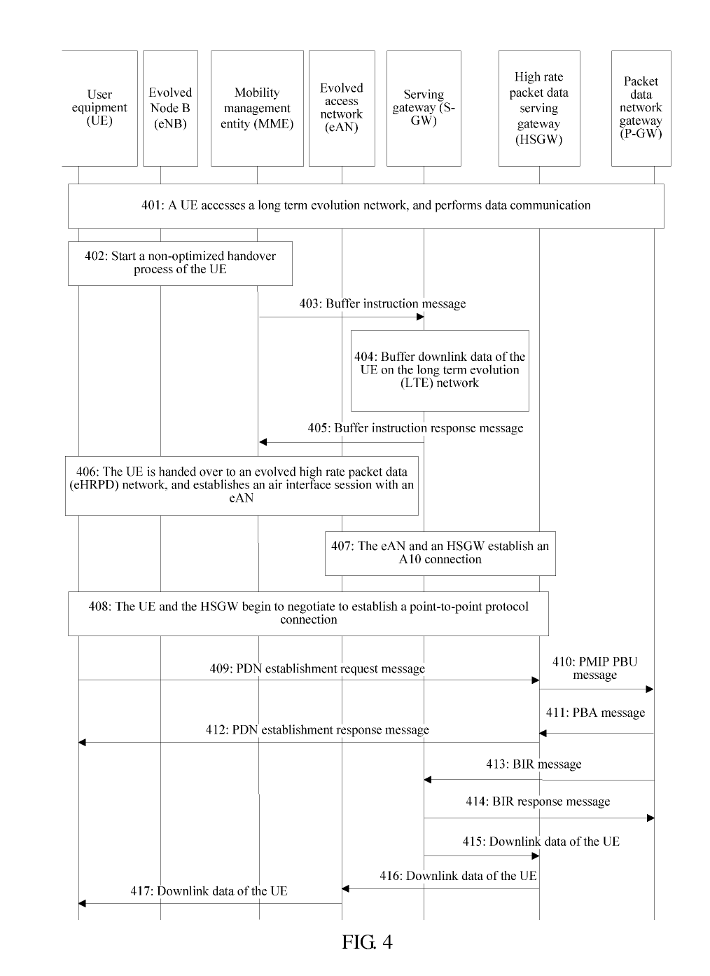

Referring to FIG. 4, a handover control method according to a second embodiment of the present invention may include the following content.

401 to 409 may be the same as steps 301 to 309 in the foregoing embodiment, which are not repeatedly described here.

410: An HSGW sends a PMIP PBU message to a P-GW.

In an application scenario, after receiving the PDN establishment request sent by the UE, the HSGW may send a PMIP PBU message to a corresponding P-GW to request to establish a data bearer between the P-GW and the HSGW. The HSGW also sends a parameter for establishing a data forwarding tunnel between the HSGW and the S-GW to the P-GW.

By taking an example that the HSGW requests to establish a GRE tunnel with the S-GW, the PMIP PBU message may carry a tunnel establishment parameter required for establishing the data forwarding tunnel, and the tunnel establishment parameter may include an IP address of the HSGW, and may further include other parameters such as a GRE key and an APN.

411: The P-GW sends a PBA message to the HSGW.

In an application scenario, after the P-GW receives the PMIP PBU message sent by the HSGW, the P-GW may establish a data bearer between the P-GW and the HSGW, and send a PBA message to the HSGW.

412: The HSGW sends a PDN establishment response message to the UE.

In an application scenario, after receiving the PBA message sent by the P-GW, the HSGW sends a PDN establishment response message to the UE to notify the UE that a PDN connection is successfully established.

413: The P-GW sends a Binding Revocation Indication (BRI) message to the S-GW to indicate the S-GW to delete the GRE tunnel which corresponds to the UE and established with the P-GW. The BRI message may carry the tunnel establishment parameter obtained from the HSGW by the P-GW.

414: The S-GW sends a Binding Revocation Acknowledge (BRA) message to the P-GW.

In an application scenario, after receiving the BRI message sent by the P-GW, the S-GW may store the tunnel establishment parameter carried in the BRI message, and may further send a BRA message to the P-GW.

415: The S-GW sends the buffered downlink data of the UE on the LTE network to the HSGW.

In an application scenario, the S-GW may establish the data forwarding tunnel between the S-GW and the HSGW according to the tunnel establishment parameter obtained from the P-GW.

If the S-GW buffers the downlink data of the UE on the LTE network, the S-GW may send the buffered downlink data of the UE on the LTE network to the HSGW through the data forwarding tunnel established between the S-GW and the HSGW.

416: The HSGW sends to the eAN the downlink data of the UE on the LTE network, where the downlink data of the UE on the LTE network is obtained from the S-GW.

417: The eAN sends to the UE the downlink data of the UE on the LTE network, where the downlink data of the UE on the LTE network is obtained by the eAN from the HSGW.

In an application scenario, the UE that is handed over to the eHRPD network receives the downlink data of the UE on the LTE network, where the downlink data of the UE on the LTE network is sent by the eAN.

It should be noted that, the foregoing actions are described as a series of steps for convenience of description, and part of the steps have no certain precedence order.

It can be seen from the foregoing technical solution that, after the UE is ready to be handed over from the LTE network to the eHRPD network, the S-GW of the LTE network buffers the downlink data of the UE on the LTE network, the S-GW sends the buffered downlink data of the UE on the LTE network to the HSGW of the eHRPD network, so that the UE that is handed over to the eHRPD network can obtain the downlink data of the UE on the LTE network from the HSGW, thus preventing the UE from losing the downlink data of the UE on the LTE network.

In the following, an example that an LTE network is the source network, an eHRPD network is the target network, a UE is handed over from the LTE network to the eHRPD network, an S-GW is responsible for buffering the downlink data of the UE on the LTE network, and the S-GW sends the downlink data of the UE on the LTE network to an HSGW through a P-GW is taken for specific description.

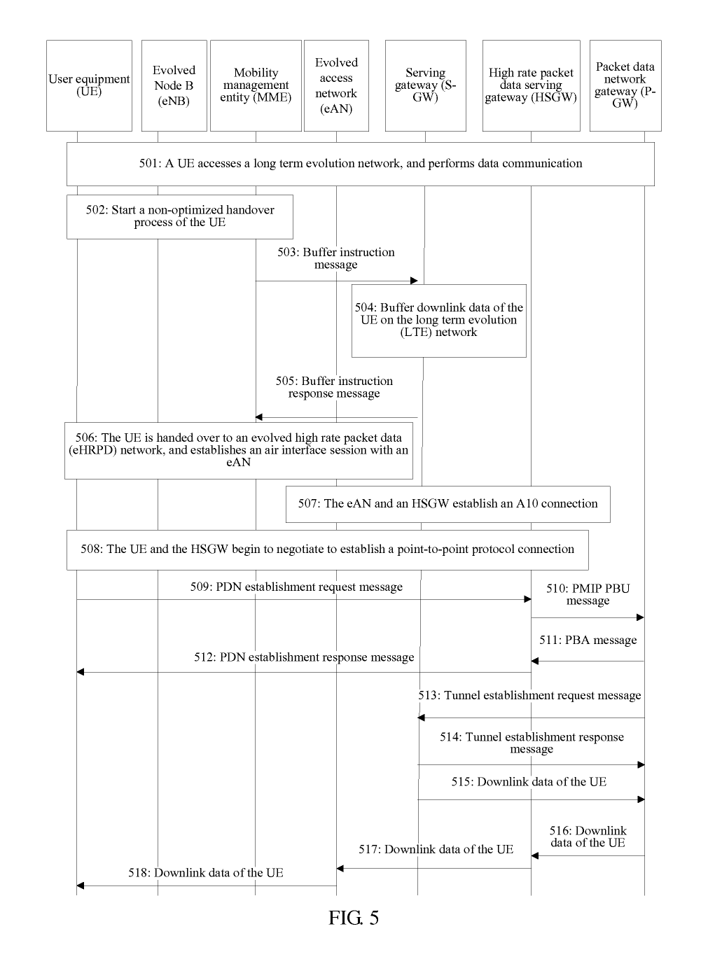

Referring to FIG. 5, a handover control method according to a third embodiment of the present invention may include the following content.

501 to 509 may be the same as steps 301 to 309 in the foregoing embodiment, which are not repeatedly described here.

510: An HSGW sends a PMIP PBU message to a P-GW.

In an application scenario, after receiving the PDN establishment request sent by the UE, the HSGW may send a PMIP PBU message to a corresponding P-GW to request to establish a data bearer between the P-GW and the HSGW.

511: The P-GW sends a PBA message to the HSGW.

In an application scenario, after receiving the PMIP PBU message sent by the HSGW, the P-GW may establish a data bearer between the P-GW and the HSGW, and send a PBA message to the HSGW.

512: The HSGW sends a PDN establishment response message to the UE.

In an application scenario, after receiving the PBA message sent by the P-GW, the HSGW may further send a PDN establishment response message to the UE to notify the UE that a PDN connection is successfully established.

513: The P-GW sends a tunnel establishment request message to the S-GW.

In an application scenario, the P-GW sends a tunnel establishment request message to the S-GW to request to establish a data forwarding tunnel between the S-GW and the P-GW, so as to obtain the downlink data of the UE on the LTE network, where the downlink data of the UE on the LTE network is buffered by the S-GW.

The P-GW may request to establish a General Packet Radio Service tunnelling protocol (GPRS Tunnelling Protocol, GTP) tunnel, a GRE tunnel, an IP in IP tunnel or other tunnels with the S-GW, which is not limited in the present invention.

In an application scenario, the tunnel establishment request message may be a BRI message or other messages, which is not limited in the present invention.

514: The S-GW sends a tunnel establishment response message to the P-GW.

In an application scenario, after the S-GW receives the tunnel establishment request message sent by the P-GW, the S-GW establishes a data forwarding tunnel between the S-GW and the P-GW according to a tunnel establishment parameter such as an IP address of the P-GW.

The S-GW may further send a tunnel establishment response message to the P-GW to notify the P-GW that a data forwarding tunnel is successfully established.

In an application scenario, the tunnel establishment response message may be a BRA message or other messages, which is not limited in the present invention.

515: The S-GW sends the downlink data of the UE on the LTE network to the P-GW.

In an application scenario, if the S-GW buffers the downlink data of the UE on the LTE network, the S-GW may send the buffered downlink data of the UE on the LTE network to the P-GW through the data forwarding tunnel established between the S-GW and the P-GW.

516: The P-GW sends to the HSGW the downlink data of the UE on the LTE network, where the downlink data of the UE on the LTE network is obtained from the S-GW.

517: The HSGW sends to the eAN the downlink data of the UE on the LTE network, where the downlink data of the UE on the LTE network is obtained from the P-GW.

518: The eAN sends to the UE the downlink data of the UE on the LTE network, where the downlink data of the UE on the LTE network is obtained by the eAN from the HSGW.

In an application scenario, the UE that is handed over to the eHRPD network receives the downlink data of the UE on the LTE network, where the downlink data of the UE on the LTE network is sent by the eAN.

It should be noted that, the foregoing actions are described as a series of steps for convenience of description, and part of the steps have no certain precedence order.

It can be seen from the foregoing technical solution that, after the UE is ready to be handed over from the LTE network to the eHRPD network, the S-GW of the LTE network buffers the downlink data of the UE on the LTE network, the S-GW sends the buffered downlink data of the UE on the LTE network to the HSGW of the eHRPD network through the P-GW, so that the UE that is handed over to the eHRPD network can obtain the downlink data of the UE on the LTE network from the HSGW, thus preventing the UE from losing the downlink data of the UE on the LTE network.

In the following, an example that an LTE network is the source network, an eHRPD network is the target network, a UE is handed over from the LTE network to the eHRPD network, an S-GW is responsible for buffering the downlink data of the UE on the LTE network, and the UE sends an IP address of the S-GW to an HSGW, and the S-GW and the HSGW establish a data forwarding tunnel is taken for specific description.

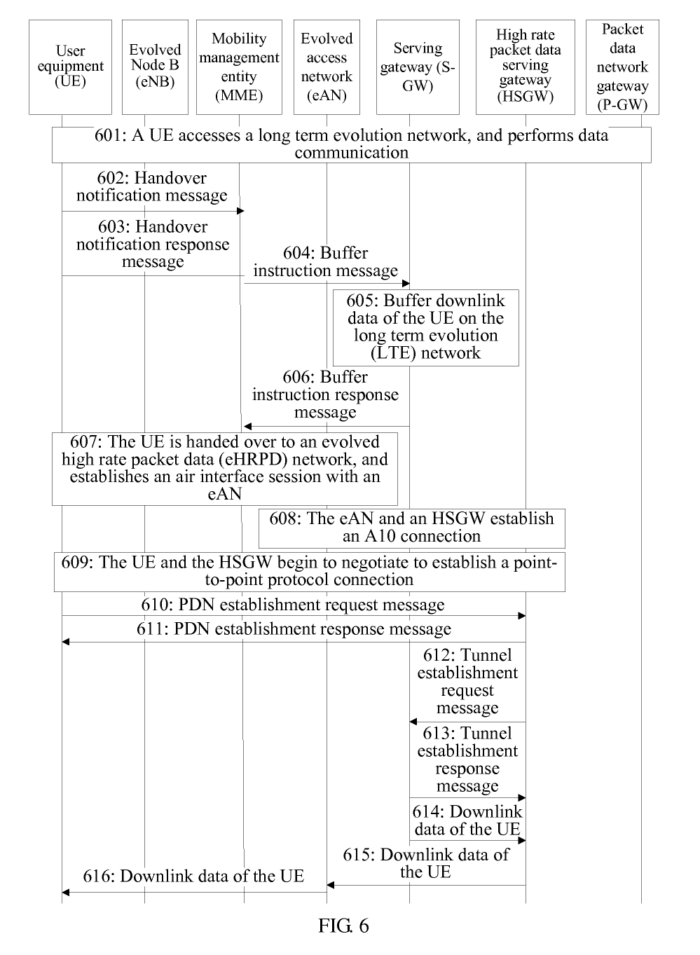

Referring to FIG. 6, a handover control method according to a fourth embodiment of the present invention may include the following content.

601 may be the same as step 301 in the foregoing embodiment, which is not repeatedly described here.

602: A UE sends a handover notification message to an MME.

In an application scenario, if the UE is ready to be handed over to an eHRPD network, the UE may send a handover notification message to the MME, where the handover notification message may carry indication information that the UE is ready to be handed over to the eHRPD network, and certainly may further carry other information.

The type of the handover notification message may be NAS signaling, which can be transparently transferred from the UE to the MME. The UE may notify, by using the handover notification message, the MME that the UE is ready to be handed over to the eHRPD network.

In an application scenario, the handover notification message sent to the MME by the UE may specifically be: a detach request message (for example, detach request), an attach request message (for example, attach), a service request message (for example, Service Request), a TAU message, or other NAS signaling, which is not limited in the present invention.

603: The MME sends a handover notification response message to the UE.

In an application scenario, after receiving the handover notification message sent by the UE, the MME acquires that the UE is ready to be handed over to the eHRPD network.

The MME may further send a handover notification response message to the UE, where the handover notification response message may carry information such as an IP address of the S-GW.

In an application scenario, the handover notification response message sent to the UE by the MME may specifically be: a response message for the detach request (for example, detach accept), an attach accept/reject message, a TAU accept message, a service accept message, or other NAS signaling, which is not limited in the present invention.

604 to 609 may be the same as steps 303 to 308 in the foregoing embodiment, which are not repeatedly described here.

610: The UE sends a PDN establishment request message to the HSGW.

In an application scenario, the UE may initiate a process for establishing a PDN connection, and the UE may send a PDN establishment request message to the HSGW to request to establish the PDN connection.

The PDN establishment request message may carry information such as the IP address of the S-GW.

In an application scenario, the PDN establishment request message may specifically be a VSNCP configuration request message or other messages, which is not limited in the present invention.

611: The HSGW sends a PDN response message to the UE.

In an application scenario, after receiving the sent PDN establishment request message, the HSGW obtains the IP address of the S-GW, and may further send a PDN establishment response message to the UE.

In an application scenario, the PDN establishment response message may specifically be a VSNCP configuration acknowledge message or other messages, which is not limited in the present invention.

612 to 615 may be the same as steps 314 to 317 in the foregoing embodiment, which are not repeatedly described here.

It should be noted that, the foregoing actions are described as a series of steps for convenience of description, and part of the steps have no certain precedence order.

It can be seen from the foregoing technical solution that, after the UE is ready to be handed over from the LTE network to the eHRPD network, the S-GW of the LTE network buffers the downlink data of the UE on the LTE network, the S-GW sends the buffered downlink data of the UE on the LTE network to the HSGW of the eHRPD network, so that the UE that is handed over to the eHRPD network can obtain the downlink data of the UE on the LTE network from the HSGW, thus preventing the UE from losing the downlink data of the UE on the LTE network.

In the following, an example that an LTE network is the source network, an eHRPD network is the target network, a UE is handed over from the LTE network to the eHRPD network, a P-GW is responsible for buffering the downlink data of the UE on the LTE network, and the P-GW sends the downlink data of the UE on the LTE network to an HSGW is taken for specific description.

Referring to FIG. 7, a handover control method according to a fifth embodiment of the present invention may include the following content.

701 to 702 may be the same as steps 301 to 302 in the foregoing embodiment, which are not repeatedly described here.

703: An MME sends a handover notification message to an S-GW.

In an application scenario, after receiving the handover notification message of the UE or the handover notification message of the eNB, the MME acquires and acknowledges that the UE is ready to be handed over to the eHRPD network, and the MME sends a handover notification message to the S-GW, where the handover notification message may carry information that the UE is ready to be handed over to the eHRPD network, and the handover notification message certainly may further carry other information.

The MME may notify, by using the handover notification message, the S-GW that the UE is ready to be handed over to the eHRPD network.

In an application scenario, the handover notification message sent to the S-GW by the MME may specifically be: an update bearer request or other messages, which is not limited in the present invention.

704: The S-GW sends a buffer instruction message to a P-GW.

In an application scenario, after receiving the handover notification message sent by the MME, the S-GW acquires and acknowledges that the UE is ready to be handed over to the eHRPD network, and the S-GW sends a buffer instruction message to the P-GW, where the buffer instruction message may carry instruction information instructing that it begins to buffer the downlink data of the UE on the LTE network, and the buffer instruction message certainly may further carry other information.

The S-GW may instruct, by using the buffer instruction message, the P-GW to begin to buffer the downlink data of the UE on the LTE network.

In an application scenario, the buffer instruction message sent to the P-GW by the S-GW may specifically be: a PBU message, a GTP-C message, or other messages, which is not limited in the present invention.

705: The P-GW buffers the downlink data of the UE on the LTE network.

In an application scenario, after receiving the buffer instruction message sent by the S-GW, the P-GW acquires and acknowledges that the UE is ready to be handed over to the eHRPD network, and the P-GW begins to buffer the downlink data of the UE on the LTE network.

706: The P-GW sends a buffer instruction response message to the S-GW.

In an application scenario, after receiving the buffer instruction message sent by the S-GW, the P-GW may further send a buffer instruction response message to the S-GW.

In an application scenario, the buffer instruction response message sent to the S-GW by the P-GW may specifically be: a PBA message, or a GTP-C message, or other messages, which is not limited in the present invention.

707: The S-GW sends a handover notification response message to the MME.

In an application scenario, after receiving the handover notification message sent by the MME, the S-GW may further send a handover notification response message to the MME.

In an application scenario, the handover notification response message sent to the MME by the S-GW may specifically be: an update bearer response or other messages, which is not limited in the present invention.

708: The UE is handed over to the eHRPD network, and establishes an air interface session with an eAN.

In an application scenario, if before being handed over to the eHRPD network, the UE has no air interface session on the eHRPD network, after being handed over to the eHRPD network, the UE establishes an air interface session with the eAN.

709: The eAN and an HSGW establish an A10 connection.

710: The UE and the HSGW negotiate to establish a PPP connection.

In an application scenario, after the eAN and the HSGW establish the A10 connection, the UE begins to negotiate with the HSGW to establish a PPP connection, and begins to establish the PPP connection.

711: The UE sends a PDN establishment request message to the HSGW.

In an application scenario, the UE may initiate a process for establishing a PDN connection, and the UE may send a PDN establishment request message to the HSGW to request to establish the PDN connection.

712: The HSGW sends a PMIP PBU message to the P-GW.

In an application scenario, after receiving the PDN establishment request sent by the UE, the HSGW may send a PMIP PBU message to a corresponding P-GW to request to establish a data bearer between the P-GW and the HSGW.

713: The P-GW sends a PBA message to the HSGW.

In an application scenario, after receiving the PMIP PBU message sent by the HSGW, the P-GW establishes a data bearer between the P-GW and the HSGW.

The P-GW may further send a PBA message to the HSGW.

714: The HSGW sends a PDN establishment response message to the UE.

In an application scenario, after receiving the PBA message sent by the P-GW, the HSGW may further send a PDN establishment response message to the UE to notify the UE that a PDN connection is successfully established.

715: The P-GW sends the downlink data of the UE on the LTE network to the HSGW.

In an application scenario, if the P-GW buffers the downlink data of the UE on the LTE network, the P-GW may send the buffered downlink data of the UE on the LTE network to the HSGW through the data bearer established between the P-GW and the HSGW.

716: The HSGW sends to the eAN the downlink data of the UE on the LTE network, where the downlink data of the UE on the LTE network is obtained by the HSGW from the P-GW.

717: The eAN sends to the UE the downlink data of the UE on the LTE network, where the downlink data of the UE on the LTE network is obtained by the eAN from the HSGW.

In an application scenario, the UE that is handed over to the eHRPD network receives the downlink data of the UE on the LTE network, where the downlink data of the UE on the LTE network is sent by the eAN.

It should be noted that, the foregoing actions are described as a series of steps for convenience of description, and part of the steps have no certain precedence order.

It can be seen from the foregoing technical solution that, after the UE is ready to be handed over from the LTE network to the eHRPD network, the P-GW buffers the downlink data of the UE on the LTE network, the P-GW sends the buffered downlink data of the UE on the LTE network to the HSGW of the eHRPD network, so that the UE that is handed over to the eHRPD network can obtain the downlink data of the UE on the LTE network from the HSGW, thus preventing the UE from losing the downlink data of the UE on the LTE network.

In the following, an example that an LTE network is the source network, an eHRPD network is the target network, a UE is handed over from the LTE network to the eHRPD network by adopting an optimized handover manner, an S-GW is responsible for buffering the downlink data of the UE on the LTE network, an HSGW obtains an IP address of an S-GW from a P-GW, and triggers to establish a data forwarding tunnel between the S-GW and the HSGW, and the S-GW sends the downlink data of the UE on the LTE network to the HSGW is taken for specific description.

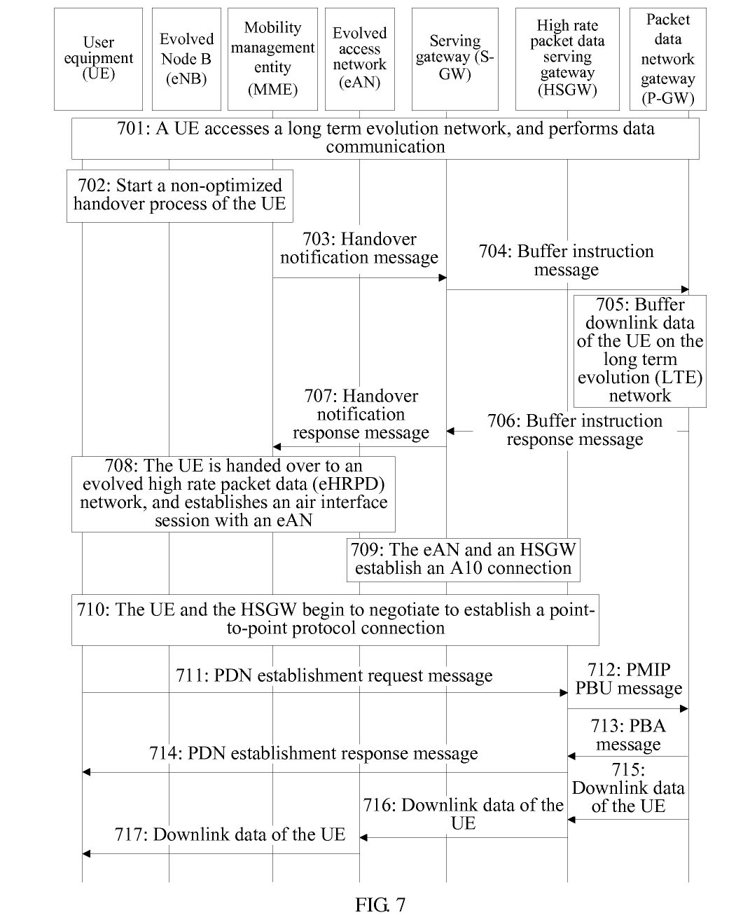

Referring to FIG. 8, a handover control method according to a sixth embodiment of the present invention may include the following content.

801: A UE accesses an LTE network, and the UE executes pre-registration to an eHRPD network through the LTE network.

802: Start an optimized handover process of the UE.

In an application scenario, if a signal of the LTE network is weakened, when it is detected that a signal of the eHRPD network is stronger than the signal of the LTE network, or due to other reasons, a network side or the UE may start the optimized handover process of the UE.

In an application scenario, starting the optimized handover process of the UE may adopt one of the following three methods, to which the present invention is not limited.

### Method 1

A21: A UE sends a handover notification message to an MME.

In an application scenario, if the UE is ready to be handed over to an eHRPD network, the UE may send a handover notification message to the MME, where the handover notification message may carry indication information that the UE is ready to be handed over to the eHRPD network, and certainly may further carry other information.

The type of the handover notification message may be NAS signaling, which can be transparently transferred from the UE to the MME. The UE may notify, by using the handover notification message, the MME that the UE is ready to be handed over to the eHRPD network.

In an application scenario, the handover notification message sent to the MME by the UE may specifically be: a detach request message, an attach request message (for example, attach), a Tracking Area Update (TAU) message, a service request message (Service Request) or other NAS signaling, which is not limited in the present invention.

A22: The MME sends a handover notification response message to the UE.

In an application scenario, after receiving the handover notification message sent by the UE, the MME acquires that the UE is ready to be handed over to the eHRPD network.

The MME may further send the handover notification response message to the UE.

In an application scenario, the handover notification response message sent to the UE by the MME may specifically be: a response message for the detach request (for example, detach accept), an attach accept/reject message, a TAU accept message, a service accept message, or other NAS signaling, which is not limited in the present invention.

### Method 2

B21: A UE sends a handover notification message to an eNB.

In an application scenario, if the UE is ready to be handed over to an eHRPD network, the UE may send a handover notification message to the eNB, where the handover notification message may carry indication information that the UE is ready to be handed over to the eHRPD network, and certainly may further carry other information.

The type of the handover notification message may be AS signaling, and the UE may notify, by using the handover notification message, the eNB that the UE is ready to be handed over to the eHRPD network.

In an application scenario, the handover notification message sent to the eNB by the UE may specifically be: an RRC connection release request message or other AS signaling, which is not limited in the present invention.

B22: The eNB sends a handover notification message to an MME.

In an application scenario, after receiving the handover notification message sent by the UE, the eNB acquires that the UE is ready to be handed over to the eHRPD network. The eNB may send a handover notification message to the MME, where the handover notification message may carry indication information that the UE is ready to be handed over to the eHRPD network, and certainly may further carry other information.

The eNB notifies, by using the handover notification message, the MME that the UE is ready to be handed over to the eHRPD network.

In an application scenario, the handover notification message sent to the MME by the eNB may specifically be: an S1-AP UE context release request, an S1-AP UE context modification request, or other messages, which is not limited in the present invention.

B23: The MME sends a handover notification response message to the eNB.

In an application scenario, after receiving the handover notification message sent by the eNB, the MME acquires that the UE is ready to be handed over to the eHRPD network.

The MME may further send a handover notification response message to the eNB.

B24: The eNB sends a handover notification response message to the UE.

In an application scenario, after receiving the handover notification message sent by the UE, the eNB acquires that the UE is ready to be handed over to the eHRPD network. The eNB may further send a handover notification response message to the UE.

### Method 3

C21: An eNB sends a handover instruction message to a UE.

The eNB may send a handover instruction message to the UE, where the handover instruction message may carry instruction information instructing the UE to be handed over to the eHRPD network, and certainly may further carry other information.

The eNB may instruct, by using the handover instruction message, the UE to begin to execute optimized handover.

C22: The eNB sends a handover notification message to an MME.

In an application scenario, after a network side decides that the UE executes optimized handover, the eNB may send a handover notification message to the MME, where the handover notification message may carry information that the UE is ready to be handed over to the eHRPD network, and the handover notification message certainly may further carry other information.

The eNB notifies, by using the handover notification message, the MME that the UE is ready to be handed over to the eHRPD network.

C23: The UE sends a handover instruction response message to the eNB.

In an application scenario, after receiving the handover instruction message sent by the eNB, the UE begins to execute an optimized handover process, and is ready to be handed over to the eHRPD network.

The UE may further send a handover instruction response message to the eNB.

C24: The MME sends a handover notification response message to the eNB.

In an application scenario, after receiving the handover notification message sent by the eNB, the MME acquires that the UE is ready to be handed over to the LTE network.

The MME may further send a handover notification response message to the eNB.

It can be seen that, through execution of one of the foregoing three operation methods, the MME can acquire that the UE is ready to be handed over to the eHRPD network, so as to further execute handover related processing.

803 to 805 may be the same as steps 303 to 305 in the foregoing embodiment, which are not repeatedly described here.

806: The UE executes optimized handover, and establishes a connection with the eAN, and the eAN allocates air interface resources.

807: The eAN sends an A11 RRQ (Registration Request) message to the HSGW.

In an application scenario, the eAN sends an A11 RRQ message to the HSGW, where the A11 RRQ message may carry instruction information that the UE has been connected to the eHRPD network, and certainly may further carry other information.

The eAN may notify, by using the A11 RRQ message, the HSGW that the UE has been connected to the eHRPD network.

808: The HSGW sends a PMIP PBU message to the P-GW.

In an application scenario, after receiving the A11 RRQ message sent by the eAN, the HSGW acquires that the UE has been connected to the eHRPD network.

The HSGW may send a PMIP PBU message to a corresponding P-GW to request to establish a data bearer between the HSGW and the P-GW.

809: The P-GW sends a PBA message to the HSGW.

In an application scenario, after receiving the PMIP PBU message sent by the HSGW, the P-GW establishes a data bearer with the HSGW.

The P-GW may further send a PBA message to the HSGW, where the PBA message may carry an IP address of a data anchor point S-GW, and certainly may further carry other information.

810: The HSGW sends an A11 RRP (Registration Reply) message to the eAN.

811 to 815 may be the same as steps 313 to 317 in the foregoing embodiment, which are not repeatedly described here.

It can be understood that this embodiment mainly describes the optimized handover of the UE, but steps 410 to 417 and steps 510 to 518 that are in the embodiments describing the non-optimized handover can also be applied in the steps after step 805 in this embodiment.

It should be noted that, the foregoing actions are described as a series of steps for convenience of description, and part of the steps have no certain precedence order.

It can be seen from the foregoing technical solution that, after the UE is ready to be handed over from the LTE network to the eHRPD network, the S-GW of the LTE network buffers the downlink data of the UE on the LTE network, the S-GW sends the buffered downlink data of the UE on the LTE network to the HSGW of the eHRPD network, so that the UE that is handed over to the eHRPD network can obtain the downlink data of the UE on the LTE network from the HSGW, thus preventing the UE from losing the downlink data of the UE on the LTE network.

For convenience of understanding the technical solution according to the embodiment of the present invention, an example that an eHRPD network is the source network, an LTE network is the target network, a UE is handed over from the eHRPD network to the LTE network, an HSGW is responsible for buffering the downlink data of the UE on the eHRPD network, an S-GW obtains an IP address of the HSGW from a P-GW, and triggers establishment of a data forwarding tunnel between the S-GW and the HSGW is taken for specific description.

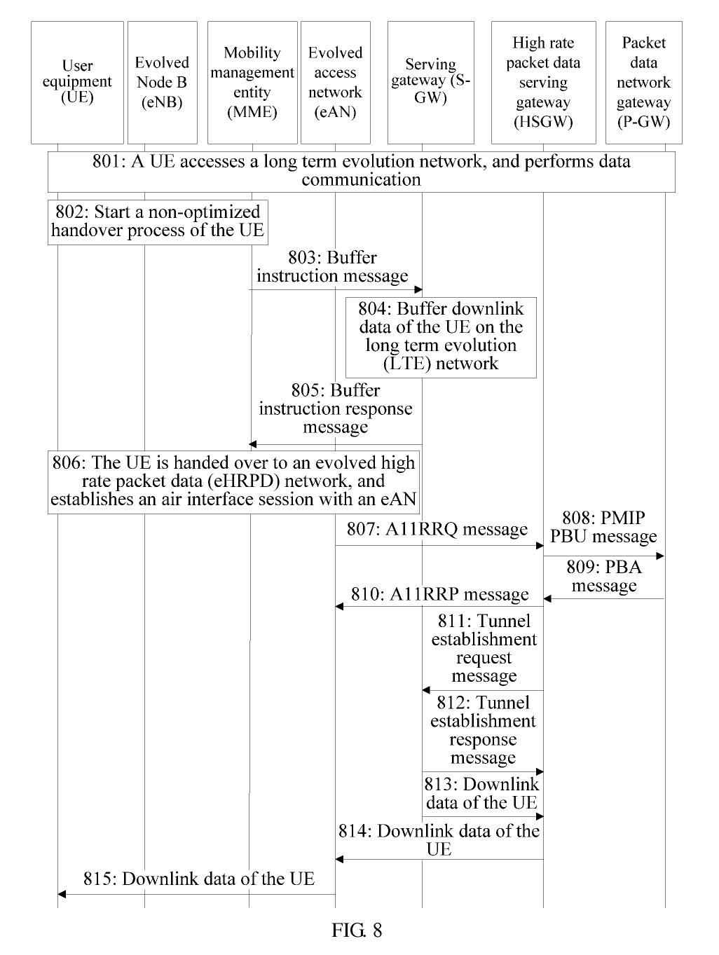

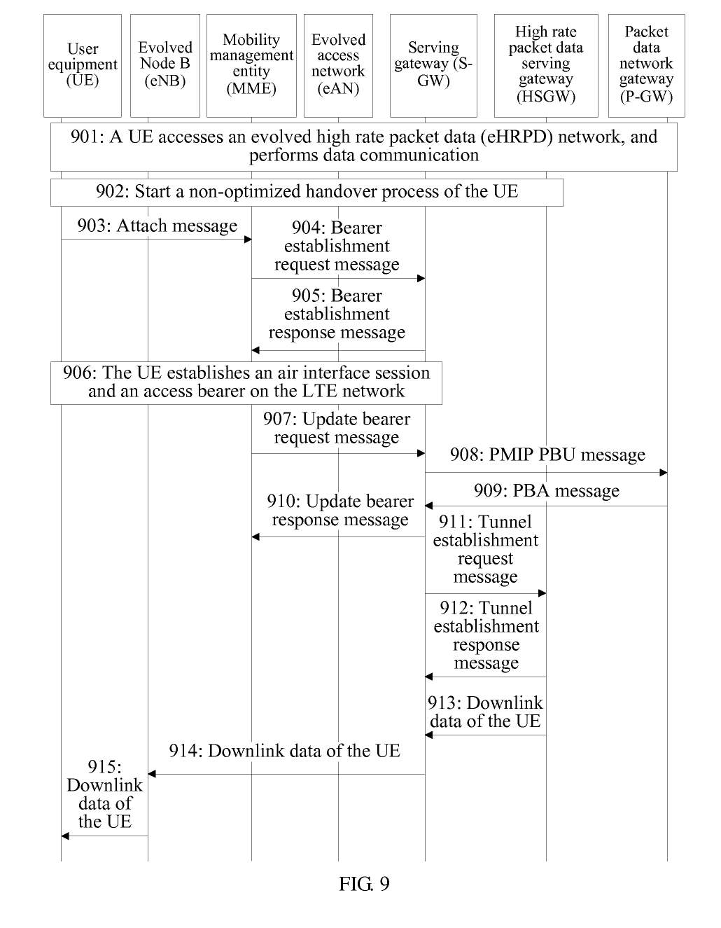

Referring to FIG. 9, a handover control method according to a seventh embodiment of the present invention may include the following content.

901: A UE accesses an eHRPD network.

In an application scenario, the UE currently accesses an eHRPD network, and the UE that accesses the eHRPD network may perform data communication with a service network or other user equipment.

902: Start a non-optimized handover process of the UE.

In an application scenario, if a signal of the eHRPD network is weakened, when it is detected that a signal of an LTE network is stronger than the signal of the eHRPD network, or due to other reasons, a network side or the UE may start the non-optimized handover process of the UE.

In an application scenario, starting the non-optimized handover process of the UE may adopt one of the following three methods, to which the present invention is not limited.

### Method 1

A31: A UE sends a buffer instruction message to an HSGW.

In an application scenario, if the UE is ready to be handed over to an LTE network, the UE may send a buffer instruction message to the HSGW, where the buffer instruction message may carry instruction information instructing that it begins to buffer the downlink data of the UE on the eHRPD network, and certainly may further carry other information.

The UE may notify, by using the buffer instruction message, the HSGW that the UE is ready to be handed over to the LTE network, and instruct the HSGW to begin to buffer the received downlink data of the UE on the eHRPD network.

In an application scenario, the buffer instruction message sent to the HSGW by the UE may specifically be: a configuration request message (for example, a message using VSNCP, Vendor Specific Network Control Protocol) in PPP, an LCP message in PPP, or other messages, which is not limited in the present invention.

A32: The HSGW sends a buffer instruction response message to the UE.

In an application scenario, after receiving the buffer instruction message sent by the UE, the HSGW acquires and acknowledges that the UE is ready to be handed over to the LTE network, and the HSGW begins to buffer the received downlink data of the UE on the eHRPD network.

The HSGW may further send a buffer instruction response message to the UE.

In an application scenario, the buffer instruction response message sent to the UE by the HSGW may specifically be: a configuration request response message (VSNCP, Vendor Specific Network Control Protocol) in PPP, an LCP message in PPP, or other messages, which is not limited in the present invention.

### Method 2

B31: A UE sends a handover notification message to an eAN.

In an application scenario, if the UE is ready to be handed over to the LTE network, the UE may send a handover notification message to the eAN, where the handover notification message carries notification information that the UE is ready to be handed over to the LTE network, and certainly may further carry other information.

The UE notifies, by using the handover notification message, the eAN that the UE is ready to be handed over to the LTE network.

In an application scenario, the handover notification message sent to the eAN by the UE may specifically be a connection request message, a route update message, or other messages, which is not limited in the present invention.

B32: The eAN sends a buffer instruction message to an HSGW.

In an application scenario, after receiving the handover notification message sent by the UE, the eAN acquires and acknowledges that the UE is ready to be handed over to the LTE network, and the eAN may send a buffer instruction message to the HSGW, where the buffer instruction message may carry instruction information instructing that it begins to buffer the downlink data of the UE, and certainly may further carry other information.

The eAN may notify, by using the buffer instruction message, the HSGW that the UE is ready to be handed over to the LTE network, and instruct the HSGW to begin to buffer the downlink data of the UE on the eHRPD network.

In an application scenario, the buffer instruction message sent to the HSGW by the eAN may specifically be an A11 signaling.

B33: The HSGW sends a buffer instruction response message to the eAN.

In an application scenario, after receiving the buffer instruction message sent by the eAN, the HSGW acquires and acknowledges that the UE is ready to be handed over to the LTE network, and the HSGW begins to buffer the received downlink data of the UE on the eHRPD network.

The HSGW may further send a buffer instruction response message to the eAN.

In an application scenario, the buffer instruction response message sent to the eAN by the HSGW may specifically be: an A11 signaling.

B34: The eAN sends a handover notification response message to the UE.

In an application scenario, after receiving the handover notification message sent by the UE, the eAN acquires that the UE is ready to be handed over to the LTE network, and may further send a handover notification response message to the UE.

In an application scenario, the handover notification response message sent to the UE by the eAN may specifically be: a Traffic Channel Assignment (TCA) message or other messages, which is not limited in the present invention.

### Method 3

C31: An eAN sends a handover instruction message to a UE.

In an application scenario, a network side may directly decide that the UE executes non-optimized handover after the UE fails to execute pre-registration of optimized handover or in other cases.

The eAN may send a handover instruction message to the UE, where the handover instruction message may carry instruction information instructing the UE to be handed over to an LTE network, and certainly may further carry other information. The eAN may instruct, by using the handover instruction message, the UE to begin to execute non-optimized handover, and to be handed over to the LTE network.

In an application scenario, the handover instruction response message sent to the UE by the eNB may specifically be: a TCA message or other messages, which is not limited in the present invention.

C32: The eAN sends a buffer instruction message to an HSGW.

In an application scenario, if the network side is ready to hand over the UE to the LTE network, the eAN may send a buffer instruction message to the HSGW, where the buffer instruction message may carry information instructing that it begins to buffer the downlink data of the UE on the eHRPD network, and certainly may further carry other information.

The eAN may notify, by using the buffer instruction message, the HSGW that the UE is ready to be handed over to the LTE network, and instruct the HSGW to begin to buffer the downlink data of the UE on the eHRPD network.

In an application scenario, the buffer instruction message sent to the HSGW by the eNB may specifically be: an A11 signaling.

It can be understood that, step C21 and step C22 have no certain precedence order, step C22 may be executed before step C21, and may also be executed synchronously with step C21.

C33: The UE sends a handover notification response message to the eAN.

In an application scenario, after receiving the handover notification message sent by the eAN, the UE begins to execute a non-optimized handover process, and begins to be handed over to the LTE network.

The UE may further send a handover notification response message to the eAN.

C34: The HSGW sends a buffer instruction response message to the eAN.

In an application scenario, after receiving the buffer instruction message sent by the eAN, the HSGW acquires and acknowledges that the UE is ready to be handed over to the LTE network, and the HSGW begins to buffer the received downlink data of the UE on the eHRPD network.

The HSGW may further send a buffer instruction response message to the eAN.

In an application scenario, the buffer instruction response message sent to the eAN by the HSGW may specifically be: an A11 signaling.

It can be seen that, through execution of one of the foregoing three operation methods, the HSGW can acquire that the UE is ready to be handed over to the LTE network, so as to further execute handover related processing.

Further, if the UE is in an activated state, the HSGW does not send the received downlink data of the UE on the eHRPD network to the eAN at this time; and if the UE is in an idle state, after receiving the downlink data of the UE on the eHRPD network, the S-GW does not trigger a process for paging a UE, so as to save network resources.

903: The UE is handed over to the LTE network.

In an application scenario, after the UE is handed over to the LTE network, the UE begins to execute an attach process, and sends an attach message to the MME.

904: The MME sends a bearer establishment request message to the S-GW.

In an application scenario, after receiving the attach message sent by the UE, the MME may send a bearer establishment request message to the S-GW to request to establish a default bearer.

905: The S-GW sends a bearer establishment response message to the MME.

In an application scenario, after receiving the bearer establishment request message sent by the MME, the S-GW may further send a bearer establishment response message to the MME.

906: The UE establishes an air interface connection and an access bearer on the LTE network.

907: The MME sends an update bearer request message to the S-GW.

In an application scenario, the MME may send an update bearer request message to the S-GW to request the S-GW to update the bearer, where the update bearer request message may carry instruction information that the UE has been handed over to the LTE network.

908: The S-GW sends a PMIP PBU message to the P-GW.

In an application scenario, after receiving the update bearer request message of the MME, the S-GW may send a PMIP PBU message to the P-GW to request to establish a data bearer between the S-GW and the P-GW.

909: The P-GW sends a PBA message to the S-GW.

In an application scenario, after receiving the PMIP PBU message sent by the S-GW, the P-GW establishes a data bearer with the S-GW.

The P-GW may further send a PBA message to the S-GW, where the PBA message may carry an IP address of a source network serving gateway HSGW, and certainly may further carry other information.

910: The S-GW sends a update bearer response message to the MME.

911: The S-GW sends a tunnel establishment request message to the HSGW.

In an application scenario, after obtaining the IP address of the HSGW, the S-GW may send a tunnel establishment request message to the HSGW to request to establish a data forwarding tunnel between the S-GW and the HSGW, so as to obtain the downlink data of the UE on the eHRPD network, where the downlink data of the UE on the eHRPD network is buffered by the HSGW. The tunnel establishment request message carries a parameter required for establishing a data forwarding tunnel.

By taking an example that the S-GW requests to establish a GRE tunnel, the tunnel establishment request message may carry a tunnel establishment parameter required for establishing the data forwarding tunnel between the S-GW and the HSGW, and the tunnel establishment parameter may include an IP address of the S-GW, and may further include other parameters such as a GRE key and an APN.

912: The HSGW sends a tunnel establishment response message to the S-GW.

In an application scenario, after receiving the tunnel establishment request message sent by the S-GW, the HSGW may store the tunnel establishment parameter carried in the tunnel establishment message.

The HSGW may establish the data forwarding tunnel between the S-GW and the HSGW according to the obtained tunnel establishment parameter. The HSGW may further send a tunnel establishment response message to the S-GW.

Further, if the UE has multiple PDN connections on the eHRPD network, the HSGW may respectively establish an independent data forwarding tunnel for each PDN connection of the UE on the eHRPD network. Each GRE key corresponds to one PDN connection, and the APN is used to identify the PDN connections.

913: The HSGW sends the downlink data of the UE on the eHRPD network to the S-GW.

In an application scenario, if the HSGW buffers the downlink data of the UE on the eHRPD network, the HSGW may send the buffered downlink data of the UE on the eHRPD network to the S-GW through the data forwarding tunnel established between the HSGW and the S-GW.

Further, if multiple data forwarding tunnels are established for the corresponding multiple PDN connections between the S-GW and the HSGW, the HSGW may respectively send, through multiple data forwarding tunnels, to the S-GW the downlink data of the UE on the eHRPD network, where the downlink data of the UE on the eHRPD network corresponds to the multiple PDN connections.

914: The S-GW sends the downlink data of the UE on the eHRPD network to the eNB.

In an application scenario, the S-GW sends the downlink data of the UE on the eHRPD network to the eNB, where the downlink data of the UE on the eHRPD network is obtained by the S-GW from the HSGW.

915: The eNB sends the downlink data of the UE on the eHRPD network to the UE, where the downlink data of the UE on the eHRPD network is obtained by the eNB from the S-GW.

In an application scenario, the UE that is handed over to the LTE network receives the downlink data of the UE on the eHRPD network, where the downlink data of the UE on the eHRPD network is sent by the eNB.

It should be noted that, the foregoing actions are described as a series of steps for convenience of description, and part of the steps have no certain precedence order.

It can be seen from the foregoing technical solution that, after the UE is ready to be handed over from the eHRPD network to the LTE network, the HSGW of the eHRPD network buffers the downlink data of the UE on the eHRPD network, the HSGW sends the buffered downlink data of the UE on the eHRPD network to the S-GW of the LTE network, so that the UE that is handed over to the LTE network can obtain the downlink data of the UE on the eHRPD network from the S-GW, thus preventing the UE from losing the downlink data of the UE on the eHRPD network.

In the following, an example that an eHRPD network is the source network, an LTE network is the target network, a UE is handed over from the eHRPD network to the LTE network, an HSGW is responsible for buffering the downlink data of the UE on the eHRPD network, and the HSGW obtains a tunnel establishment parameters from the P-GW, and triggers to establish a data forwarding tunnel is taken for specific description.

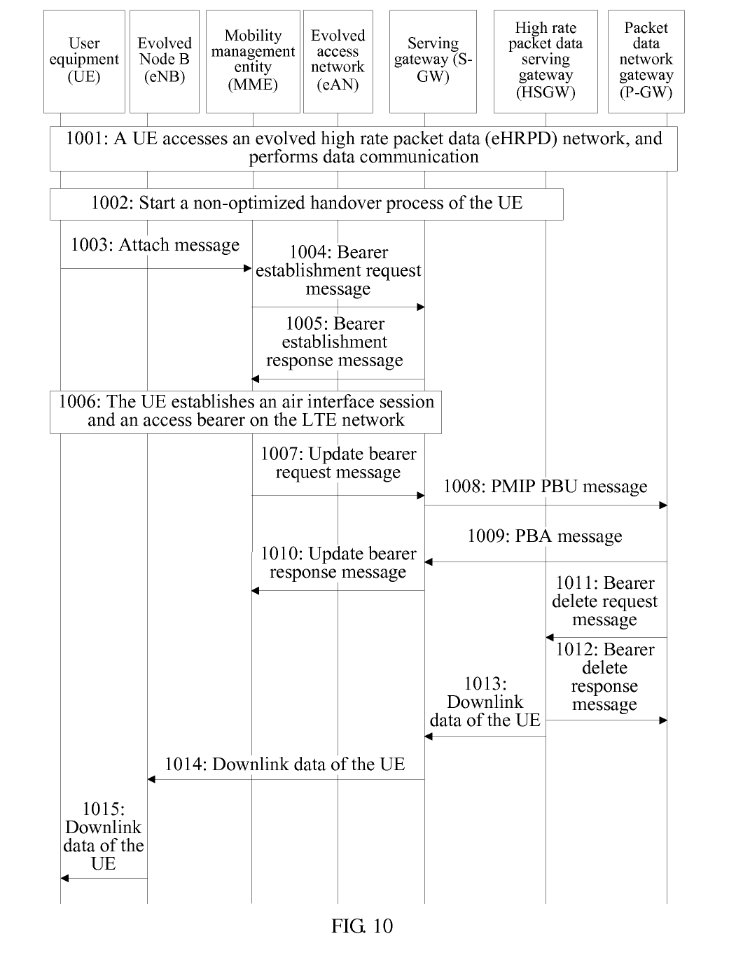

Referring to FIG. 10, a handover control method according to an eighth embodiment of the present invention may include the following content.

1001 to 1007 may be the same as steps 901 to 907 in the foregoing embodiment, which are not repeatedly described here.

1008: The S-GW sends a PMIP PBU message to the P-GW.

In an application scenario, after receiving the update bearer request message of the MME, the S-GW sends a PMIP PBU message to the P-GW to request to establish a data bearer between the S-GW and the P-GW.

By taking an example that the PMIP PBU message may carry a tunnel establishment parameter required for establishing the data forwarding tunnel between the S-GW and the HSGW, and the S-GW request to establish a GRE tunnel with the HSGW, the tunnel establishment parameter may include an IP address of the S-GW, and may further include other parameters such as a GRE key and an APN.

1009: The P-GW sends a PBA message to the S-GW.

In an application scenario, after receiving the PMIP PBU message sent by the S-GW, the P-GW establishes a data bearer with the S-GW. The P-GW sends a PBA message to the S-GW.

1010: The S-GW sends a update bearer response message to the MME.

1011: The P-GW sends a bearer delete instruction message to the HSGW.

In an application scenario, the P-GW may send a bearer delete instruction message to the HSGW, where the bearer delete instruction message carries instruction information instructing that the data bearer from the HSGW to the P-GW should be deleted.

The P-GW may carry a relevant tunnel establishment parameter which is required for establishing the data forwarding tunnel between the S-GW and the HSGW and obtained by the P-GW from the S-GW in the bearer delete instruction message.

In an application scenario, the bearer delete instruction message sent to the HSGW by the P-GW may be a BRI message or other messages, which is not limited in the present invention.

1012: The HSGW sends a bearer delete response message to the P-GW.

In an application scenario, after receiving the bearer delete instruction message sent by the P-GW, the HSGW may delete the data bearer between the HSGW and the P-GW.

The HSGW may further send a bearer delete response message to the P-GW.

The HSGW may store the relevant tunnel establishment parameter which is required for establishing the data forwarding tunnel between the S-GW and the HSGW and obtained by the HSGW from the P-GW. The HSGW establishes the data forwarding tunnel between the S-GW and the HSGW according to the obtained tunnel establishment parameter.

In an application scenario, the bearer delete response message sent to the P-GW by the HSGW may be a BRA message or other messages.

1013: The HSGW sends the buffered downlink data of the UE on the eHRPD network to the S-GW.

In an application scenario, if the HSGW buffers the downlink data of the UE on the eHRPD network, the HSGW may send the buffered downlink data of the UE on the eHRPD network to the S-GW through the data forwarding tunnel established between the HSGW and the S-GW.

1014 to 1015 may be the same as steps 914 to 915 in the foregoing embodiment, which are not repeatedly described here.

It can be seen from the foregoing technical solution that, after the UE is ready to be handed over from the eHRPD network to the LTE network, the HSGW of the eHRPD network buffers the downlink data of the UE on the eHRPD network, the HSGW sends the buffered downlink data of the UE on the eHRPD network to the S-GW of the LTE network, so that the UE that is handed over to the LTE network can obtain the downlink data of the UE on the eHRPD network from the S-GW, thus preventing the UE from losing the downlink data of the UE on the eHRPD network.

In the following, an example that an eHRPD network is the source network, an LTE network is the target network, a UE is handed over from the eHRPD network to the LTE network, an HSGW is responsible for buffering the downlink data of the UE on the eHRPD network, and the

HSGW sends the downlink data of the UE on the eHRPD network to the S-GW through a P-GW, where the downlink data of the UE on the eHRPD network is buffered by the HSGW, is taken for specific description.

Referring to FIG. 11, a handover control method according to a ninth embodiment of the present invention may include the following content.

1101 to 1108 may be the same as steps 901 to 908 in the foregoing embodiment, which are not repeatedly described here.

1109: The P-GW sends a PBA message to the S-GW.

In an application scenario, after receiving the PMIP PBU message sent by the S-GW, the P-GW establishes a data bearer with the S-GW.

The P-GW may further send a PBA message to the S-GW.

1110: The S-GW sends a update bearer response message to the MME.

1111: The P-GW sends a tunnel establishment request message to the HSGW.

In an application scenario, the P-GW sends a tunnel establishment request message to the HSGW to request to establish a data forwarding tunnel between the P-GW and the HSGW, so as to obtain the downlink data of the UE on the eHRPD network, where the downlink data of the UE on the eHRPD network is buffered by the HSGW.

The tunnel establishment request message may carry a tunnel establishment parameter required for establishing a data forwarding tunnel between the HSGW and the P-GW. By taking an example that the S-GW requests to establish a GRE tunnel, the tunnel establishment parameter may include an IP address of the S-GW, and may further include other parameters such as a GRE key and an APN.

In an application scenario, the tunnel establishment request message sent to the HSGW by the P-GW may be a BRI message or other messages.

1112: The HSGW sends a tunnel establishment response message to the P-GW.

In an application scenario, after receiving the data request message sent by the P-GW, the HSGW may store the tunnel establishment parameter required for establishing the data forwarding tunnel between the HSGW and the P-GW.

The HSGW may establish the data forwarding tunnel between the HSGW and the P-GW according to the obtained tunnel establishment parameter. The HSGW may further send a tunnel establishment response message to the P-GW.

In an application scenario, the tunnel establishment response message sent to the P-GW by the HSGW may be a BRA message or other messages.

1113: The HSGW sends the downlink data of the UE on the eHRPD network to the P-GW.

In an application scenario, if the HSGW buffers the downlink data of the UE on the eHRPD network, the HSGW may send the buffered downlink data of the UE on the eHRPD network to the P-GW through the data forwarding tunnel established between the HSGW and the S-GW.

1114: The P-GW sends to the S-GW the downlink data of the UE on the eHRPD network, where the downlink data of the UE on the eHRPD network is obtained by the P-GW from the HSGW.

1115: The S-GW sends to an eNB the downlink data of the UE on the eHRPD network, where the downlink data of the UE on the eHRPD network is obtained by the S-GW from the P-GW.

1116: The eNB sends to the UE the downlink data of the UE on the eHRPD network, where the downlink data of the UE on the eHRPD network is obtained from the S-GW.

In an application scenario, the UE that is handed over to the LTE network receives the downlink data of the UE on the eHRPD network, where the downlink data of the UE on the eHRPD network is sent by the eNB.

It should be noted that, the foregoing actions are described as a series of steps for convenience of description, and part of the steps have no certain precedence order.

It can be seen from the foregoing technical solution that, after the UE is ready to be handed over from the eHRPD network to the LTE network, the HSGW of the eHRPD network buffers the downlink data of the UE on the eHRPD network, the HSGW sends the buffered downlink data of the UE on the eHRPD network to the S-GW of the LTE network through the P-GW, so that the UE that is handed over to the LTE network can obtain the downlink data of the UE on the eHRPD network from the S-GW, thus preventing the UE from losing the downlink data of the UE on the eHRPD network.

In the following, an example that an eHRPD network is the source network, an LTE network is the target network, a UE is handed over from the eHRPD network to the LTE network, an HSGW is responsible for buffering the downlink data of the UE, where the UE transfers an address of the HSGW to the LTE network is taken for specific description.

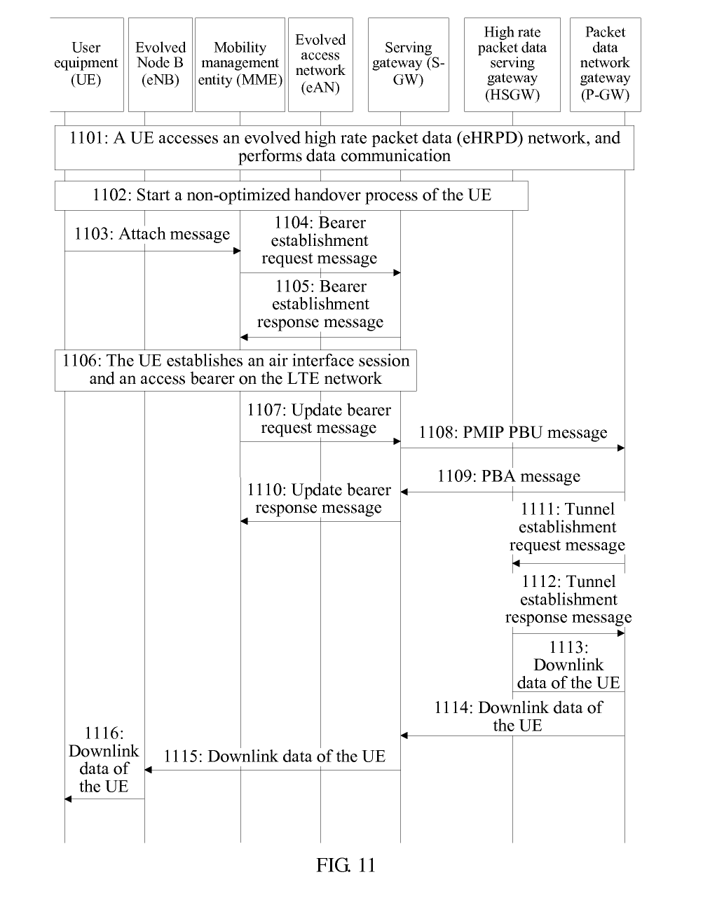

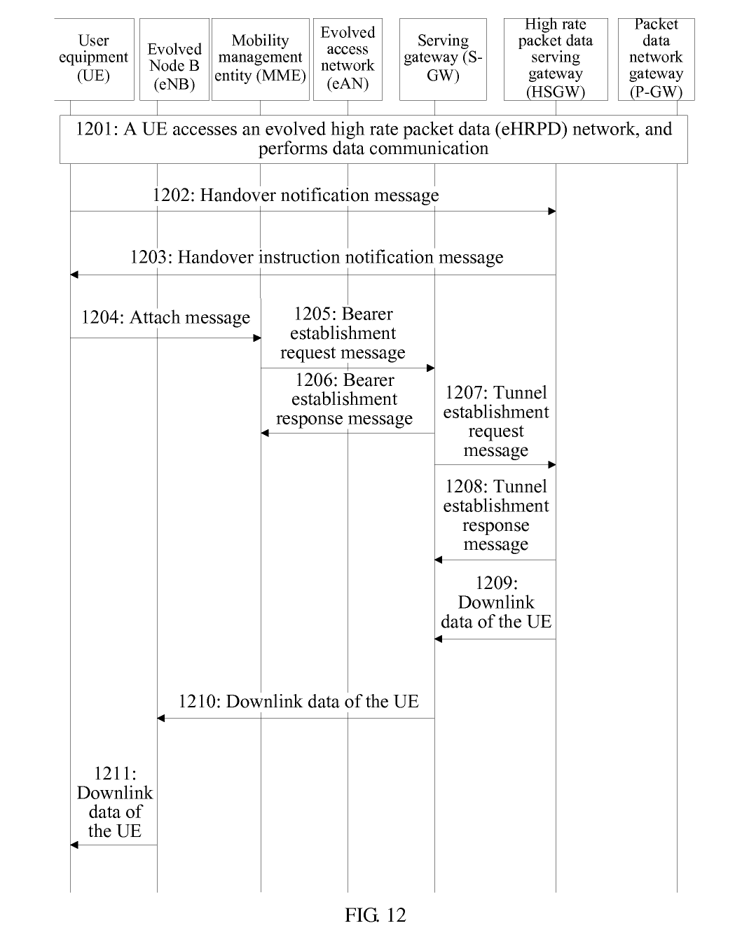

Referring to FIG. 12, a handover control method according to a tenth embodiment of the present invention may include the following content.

1201 may be the same as step 901 in the foregoing embodiment, which is not repeatedly described here.

1202: A UE sends a buffer instruction message to an HSGW.

In an application scenario, if the UE is ready to be handed over to an LTE network, the UE may send a buffer instruction message to the HSGW, where the buffer instruction message may carry instruction information instructing that it begins to buffer the downlink data of the UE on the eHRPD network, and certainly may further carry other information.

The UE may notify, by using the buffer instruction message, the HSGW that the UE is ready to be handed over to the LTE network, and instruct the HSGW to begin to buffer the downlink data of the UE on the eHRPD network.

In an application scenario, the buffer instruction message sent to the HSGW by the UE may be a VSNCP message or other messages.

1203: The HSGW sends a buffer instruction response message to the UE.

In an application scenario, after receiving the buffer instruction message sent by the UE, the HSGW acquires and acknowledges that the UE is ready to be handed over to the LTE network, and the HSGW begins to buffer the received downlink data of the UE on the eHRPD network.

Further, if the UE is in an activated state, after receiving the downlink data of the UE, the HSGW does not send the received downlink data of UE on the eHRPD network to an eAN; and if the UE is in an idle state, after receiving the downlink data of the UE on the eHRPD network, the HSGW does not trigger a process for paging a UE, so as to save network resources.

The HSGW may further send a buffer instruction response message to the UE, and if the UE does not obtain an IP address of the HSGW currently, the buffer instruction response message may carry IP address information of the HSGW.

In an application scenario, the buffer instruction response message sent to the UE by the HSGW may be a VSNCP message or other messages.

1204: The UE is handed over to the LTE network.

In an application scenario, after the UE is handed over to the LTE network, the UE begins to execute an attach process, sends an attach message to an MME, where the attach message may carry the IP address information of the HSGW.

1205: The MME sends a bearer establishment request message to the S-GW.

In an application scenario, after receiving the attach message sent by the UE, the MME may send a bearer establishment request message to the S-GW to request to establish a default bearer.

The bearer establishment request message may carry information such as the IP address of the HSGW.

1206: The S-GW sends a bearer establishment response message to the MME.

In an application scenario, after receiving the bearer establishment request message sent by the MME, the S-GW establishes a data bearer between the S-GW and the MME, and stores information such as the IP address of the HSGW, where the IP address of the HSGW is carried in the bearer establishment request message.

The S-GW may further send a bearer establishment response message to the MME.

1207 to 1211 may be the same as steps 911 to 915 in the foregoing embodiment, which are not repeatedly described here.

It should be noted that, the foregoing actions are described as a series of steps for convenience of description, and part of the steps have no certain precedence order.

It can be seen from the foregoing technical solution that, after the UE is ready to be handed over from the eHRPD network to the LTE network, the HSGW of the eHRPD network buffers the downlink data of the UE on the eHRPD network, the HSGW sends the buffered downlink data of the UE on the eHRPD network to the S-GW of the LTE network, so that the UE that is handed over to the LTE network can obtain the downlink data of the UE on the eHRPD network from the S-GW, thus preventing the UE from losing the downlink data of the UE on the eHRPD network.

In the following, an example that an eHRPD network is the source network, an LTE network is the target network, a UE is handed over from the eHRPD network to the LTE network, a P-GW is responsible for buffering the downlink data of the UE on the eHRPD network, and the P-GW sends the downlink data of the UE on the eHRPD network to an S-GW is taken for specific description.

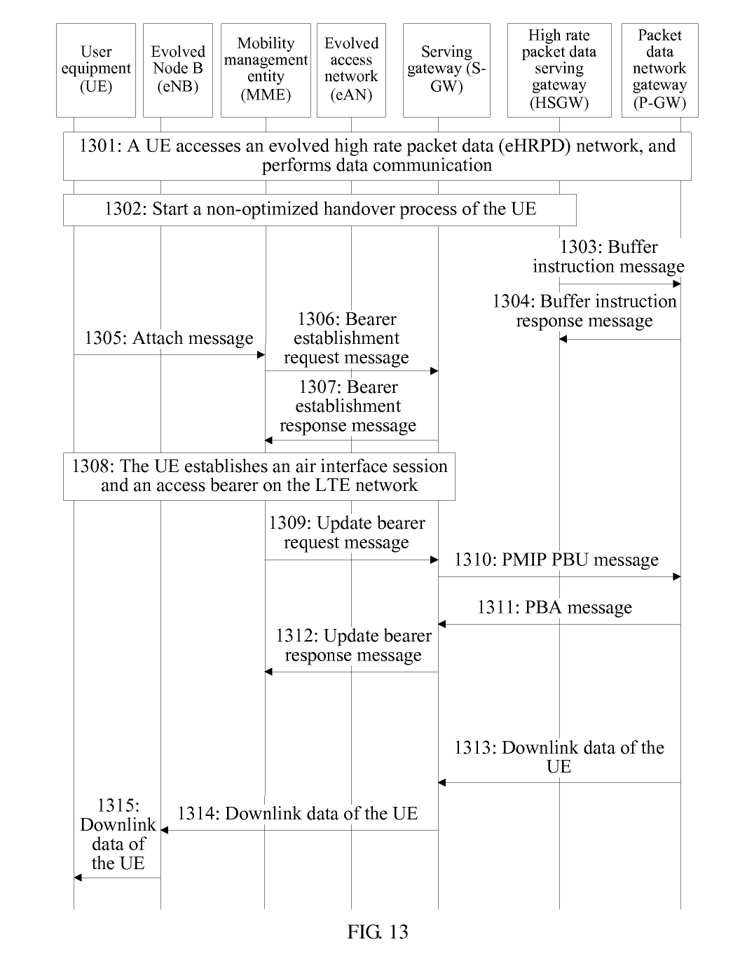

Referring to FIG. 13, a handover control method according to an eleventh embodiment of the present invention may include the following content.

1301 may be the same as step 901 in the foregoing embodiment, which is not repeatedly described here.

1302: Start a non-optimized handover process of the UE.

In an application scenario, if a signal of an eHRPD network is weakened, when it is detected that a signal of an LTE network is stronger than the signal of the eHRPD network, or due to other reasons, a network side or the UE may start the non-optimized handover process of the UE.

In an application scenario, starting the non-optimized handover process of the UE may adopt one of the following three methods, to which the present invention is not limited.

### Method 1

A41: A UE sends a handover notification message to an HSGW.

In an application scenario, if the UE is ready to be handed over to an LTE network, the UE may send a handover notification message to the HSGW, where the handover notification message may carry notification information that the UE is ready to be handed over to the LTE network, and certainly may further carry other information.

The UE may notify, by using the handover notification message, the HSGW that the UE is ready to be handed over to the LTE network.

In an application scenario, the handover notification message sent to the HSGW by the UE may specifically be: a configuration request message (for example, a message using VSNCP, Vendor Specific Network Control Protocol) in PPP, an LCP message in PPP, or other messages, which is not limited in the present invention.

A42: The HSGW sends a handover notification response message to the UE.

In an application scenario, after receiving the handover notification message sent by the UE, the HSGW acquires and acknowledges that the UE is ready to be handed over to the LTE network, and the HSGW may further send a handover notification response message to the UE.

In an application scenario, the handover notification response message sent to the UE by the HSGW may specifically be: a configuration request response message (for example, a message using VSNCP, Vendor Specific Network Control Protocol) in PPP, an LCP message in PPP, or other messages, which is not limited in the present invention.

### Method 2

B41: A UE sends a handover notification message to an eAN.

In an application scenario, if the UE is ready to be handed over to the LTE network, the UE may send a handover notification message to the eAN, where the handover notification message carries notification information that the UE is ready to be handed over to the LTE network, and certainly may further carry other information.

The UE may notify, by using the handover notification message, the eAN that the UE is ready to be handed over to the LTE network.

In an application scenario, the handover notification message sent to the eAN by the UE may specifically be: a connection request message, a route update message, or other messages, which is not limited in the present invention.

B42: The eAN sends a handover notification message to the HSGW.

In an application scenario, after receiving the handover notification message sent by the UE, the eAN acquires that the UE is ready to be handed over to the LTE network, the eAN sends a handover notification message to the HSGW, where the handover notification message carries notification information that the UE is ready to be handed over to the LTE network, and certainly may further carry other information.

The eAN may notify, by using the handover notification message, the HSGW that the UE is ready to be handed over to the LTE network.

B43: The HSGW sends a handover notification response message to the eAN.

In an application scenario, after receiving the handover notification message sent by the eAN, the HSGW acquires and acknowledges that the UE is ready to be handed over to the LTE network.

The HSGW may further send a handover notification response message to the eAN.

B44: The eAN sends a handover notification response message to the UE.

In an application scenario, after receiving the handover notification message sent by the UE, the eAN acquires that the UE is ready to be handed over to the LTE network, and may further send a handover notification response message to the UE.

In an application scenario, the handover notification response message sent to the UE by the eAN may specifically be: a TCA message or other messages, which is not limited in the present invention.

### Method 3

C41: An eAN sends a handover instruction message to a UE.

In an application scenario, a network side may directly decide that the UE executes non-optimized handover after the UE fails to execute pre-registration of optimized handover or in other cases.

The eAN may send a handover instruction message to the UE, where the handover instruction message may carry instruction information instructing the UE to be handed over to the LTE network, and certainly may further carry other information. The eAN may instruct, by using the handover instruction message, the UE to begin to execute non-optimized handover, and to be handed over to the LTE network.

In an application scenario, the handover instruction message sent to the UE by the eAN may specifically be: a TCA message or other messages, which is not limited in the present invention.

C42: The eAN sends a handover notification message to the HSGW.

In an application scenario, if a network side is ready to hand over the UE to the LTE network, the eNB may send a handover notification message to the HSGW, where the handover notification message may carry notification information that the UE is ready to be handed over to the LTE network, and certainly may further carry other information.

The eAN notifies, by using the handover notification message, the HSGW that the UE is ready to be handed over to the LTE network.

It can be understood that, step C41 and step C42 have no certain precedence order, step C42 may be executed before step C41, and may also be executed synchronously with step C41.

C43: The UE sends a handover instruction response message to the eAN.

In an application scenario, after receiving the handover instruction message sent by the eAN, the UE begins to execute a non-optimized handover process, and begins to be handed over to the LTE network.

The UE may further send a handover notification response message to the eAN.

C44: The HSGW sends a handover notification response message to the eAN.

In an application scenario, after receiving the handover notification message sent by the eNB, the HSGW acquires and acknowledges that the UE is ready to be handed over to the LTE network.

The HSGW may further send a handover notification response message to the eNB.

It can be seen that, through execution of one of the foregoing three operation methods, the HSGW can acquire that the UE is ready to be handed over to the LTE network, so as to further execute handover related processing.

1303: The HSGW sends a buffer instruction message to a P-GW.

In an application scenario, after acquiring that the UE is ready to be handed over to the LTE network, the HSGW may send a buffer instruction message to the P-GW, where the buffer instruction message may carry instruction information instructing that it begins to buffer the downlink data of the UE on the eHRPD network, and certainly may further carry other information.

The HSGW may notify, by using the buffer instruction message, the P-GW that the UE is ready to be handed over to the LTE network, and instruct the HSGW to begin to buffer the downlink data of the UE on the eHRPD network.

1304: The P-GW sends a buffer instruction response message to the HSGW.

In an application scenario, after receiving the buffer instruction message sent by the HSGW, the P-GW acquires and acknowledges that the UE is ready to be handed over to the LTE network, and the P-GW begins to buffer the downlink data of the UE on the eHRPD network.

The P-GW may further send a buffer instruction response message to the HSGW.

1305 to 1312 may be the same as steps 903 to 910 in the foregoing embodiment, and the only difference is that the P-GW in step 909 does not need to send the IP address of the HSGW to the S-GW, which are not repeatedly described here.

1313: The P-GW sends the buffered downlink data of the UE on the eHRPD network to the S-GW.

In an application scenario, if the P-GW buffers the downlink data of the UE on the eHRPD network, the P-GW may send the buffered downlink data of the UE on the eHRPD network to the S-GW through the data bearer between the P-GW and the S-GW.

1314: The S-GW sends to an eNB the downlink data of the UE on the eHRPD network, where the downlink data of the UE on the eHRPD network is obtained by the S-GW from the P-GW.

1315: The eNB sends to the UE the downlink data of the UE on the eHRPD network, where the downlink data of the UE on the eHRPD network is obtained by the eNB from the S-GW.

In an application scenario, the UE that is handed over to the LTE network receives the downlink data of the UE on the eHRPD network, where the downlink data of the UE on the eHRPD network is sent by the eNB.

It should be noted that, the foregoing actions are described as a series of steps for convenience of description, and part of the steps have no certain precedence order.

It can be seen from the foregoing technical solution that, after the UE is ready to be handed over from the eHRPD network to the LTE network, the P-GW buffers the downlink data of the UE on the eHRPD network, the P-GW sends the buffered downlink data of the UE on the eHRPD network to the S-GW of the LTE network, so that the UE that is handed over to the LTE network can obtain the downlink data of the UE on the eHRPD network from the S-GW, thus preventing the UE from losing the downlink data of the UE on the eHRPD network.

For convenience of implementing the technical solutions according to the embodiments of the present invention, an embodiment of the present invention further provides a serving gateway.

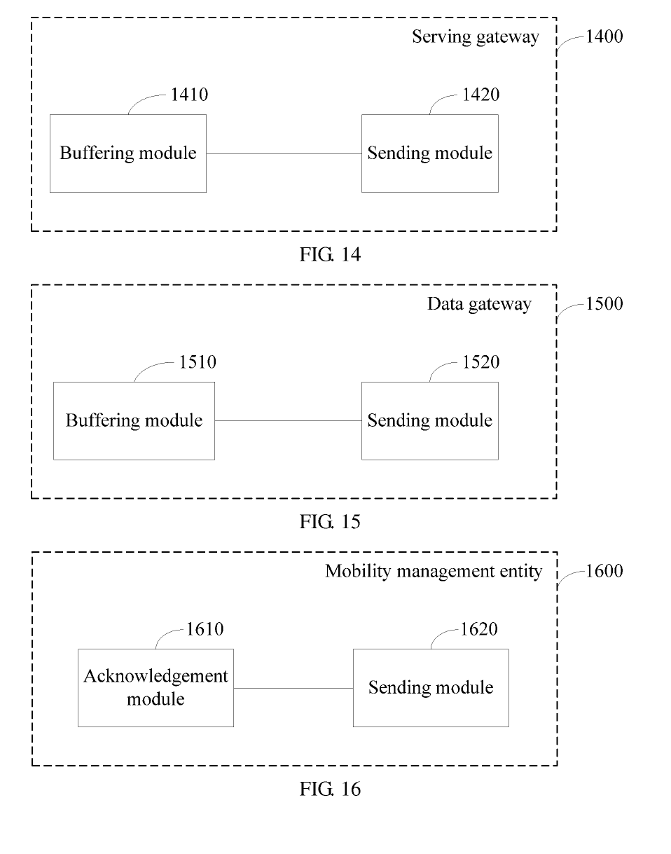

Referring to FIG. 14, a serving gateway 1400 according to a twelfth embodiment of the present invention may include: a buffering module 1410 and a sending module 1420.

The buffering module 1410 is configured to, after acquiring that a user terminal is ready to be handed over to a target network, buffer downlink data of the user terminal on a source network.

In an application scenario, the buffering module 1410 may acquire that the user terminal is ready to be handed over from a source network to a target network through many manners.

For example, after receiving a message carrying instruction information that the user is ready to be handed over from the source network to the target network, or after receiving a message carrying information instructing that the downlink data of the user on the source network should be buffered, the buffering module 1410 may know and acknowledge that the user is ready to be handed over from the source network to the target network, and begin to buffer the obtained downlink data of the user on the source network.

The sending module 1420 is configured to send the downlink data buffered by the buffering module 1410 to a serving gateway of the target network.

In an application scenario, the sending module 1420 may directly send the downlink data of the user on the source network, where the downlink data of the user on the source network is buffered by the buffering module 1410, to the serving gateway of the target network, and certainly may forward the downlink data of the user on the source network, where the downlink data of the user on the source network is buffered by the buffering module 1410, to the serving gateway of the target network through another device.

In an application scenario, the sending module 1420 may include a first tunnel establishment sub-module and a first sending sub-module (not shown in FIG. 14).

The first tunnel establishment sub-module is configured to establish a data forwarding tunnel with the serving gateway of the target network; and

The first sending sub-module is configured to send the downlink data buffered by the buffering module 1410 to the serving gateway of the target network through the data forwarding tunnel established by the first tunnel establishment sub-module.

In practical application, the first tunnel establishment sub-module may specifically be configured to obtain a tunnel establishment parameter from a data gateway or the serving gateway of the target network, and establish the data forwarding tunnel with the serving gateway of the target network according to the obtained tunnel establishment parameter.

In an application scenario, the sending module 1420 may include a second tunnel establishment sub-module and a second sending sub-module (not shown in FIG. 14).

The second tunnel establishment sub-module is configured to establish the data forwarding tunnel with a data gateway.

The second sending sub-module is configured to send the downlink data buffered by the buffering module 1410 to the serving gateway of the target network through the data gateway.

In practical application, the first tunnel establishment sub-module may specifically be configured to obtain a tunnel establishment parameter required for establishing the data forwarding tunnel with the data gateway from the data gateway, and establish a data forwarding tunnel with the data gateway according to the obtained tunnel establishment parameter.

The second sending sub-module is configured to send the downlink data of the user on the source network, where the downlink data of the user on the source network is buffered by the buffering module 1410, to the data gateway through the data forwarding tunnel established with the data gateway, so as to further send the downlink data of the user on the source network, where the downlink data of the user on the source network is buffered by the buffering module 1410, to the serving gateway of the target network through the data gateway.

It can be understood that, the serving gateway 1400 may be the S-GW or the HSGW in the foregoing method embodiments, or another network entity that has the similar function, and the data gateway may be the P-GW in the foregoing method embodiments.

The source network and the target network may be networks adopting different access technologies.

After the UE is handed over to the target network, the UE may obtain the downlink data of the UE on the source network from the serving gateway of the target network.

In an application scenario, the source network is an LTE network, the target network is an eHRPD network, the serving gateway of the source network may be an S-GW, the serving gateway of the target network may be an HSGW, and the data gateway may be a P-GW.

In another application scenario, the source network is an eHRPD network, the target network is an LTE network, the serving gateway of the source network may be an HSGW, the serving gateway of the target network may be an S-GW, and the data gateway may be a P-GW.

It can be understood that, a function of each functional module of the serving gateway 1400 may be specifically implemented according to the methods in the foregoing method embodiments, and for specific implementation processes, reference may be made to relevant description in the foregoing method embodiments, and details are not repeatedly described here.

It can be seen from the foregoing technical solution that, in this embodiment, after the UE is ready to be handed over from the source network to the target network, the serving gateway buffers the downlink data of the UE on the source network, and sends the buffered downlink data of the UE on the source network to the serving gateway of the target network, so that the UE that is handed over to the target network can obtain the downlink data of the UE on the source network from the target network, thus preventing the UE from losing the downlink data of the UE on the source network.

For convenience of implementing the technical solutions according to the embodiments of the present invention, an embodiment of the present invention further provides a data gateway.

Referring to FIG. 15, a data gateway 1500 according to a thirteenth embodiment of the present invention may include: a buffering module 1510 and a sending module 1520.

The buffering module 1510 is configured to, after acquiring that a user terminal is ready to be handed over to a target network, buffer downlink data of the user terminal on the source network.

In an application scenario, the buffering module 1510 may acquire that the user is ready to be handed over from a source network to a target network through many manners.

For example, after receiving a message carrying information instructing that the downlink data of the user on the source network should be buffered, the buffering module 1510 may know and acknowledge that the user is ready to be handed over from the source network to the target network, and begin to buffer the obtained downlink data of the user on the source network.

The sending module 1520 is configured to send the downlink data buffered by the buffering module 1510 to a serving gateway of the target network.

In an application scenario, after a data bearer between the data gateway and a serving gateway of the target network is established, the sending module 1520 may send the downlink data of the user on the source network, where the downlink data of the user on the source network is buffered by the buffering module 1510, to the serving gateway of the target network.

In an application scenario, the data gateway 1500 may be the P-GW in the foregoing method embodiments or another network entity that has the similar function. The serving gateway of the target network may be the S-GW or the HSGW in the foregoing method embodiments.

It can be understood that, a function of each functional module of the data gateway 1500 may be specifically implemented according to the methods in the foregoing method embodiments, and for specific implementation processes, reference may be made to relevant description in the foregoing method embodiments, and details are not repeatedly described here.

It can be seen from the foregoing technical solution that, in this embodiment, after the UE is ready to be handed over from the source network to the target network, the data gateway buffers the downlink data of the UE on the source network, and sends the buffered downlink data of the UE on the source network to the serving gateway of the target network, so that the UE that is handed over to the target network can obtain the downlink data of the UE on the source network from the target network, thus preventing the UE from losing the downlink data of the UE on the source network.

For convenience of implementing the technical solutions according to the embodiments of the present invention, an embodiment of the present invention further provides a mobility management entity.

Referring to FIG. 16, a mobility management entity 1600 according to a fourteenth embodiment of the present invention may include: an acknowledgement module 1610 and a sending module 1620.

The acknowledgement module 1610 is configured to acknowledge that a user is ready to be handed over from a long term evolution network to an evolved high rate packet data network.

In an application scenario, after receiving a handover notification message sent by a user equipment or an access network device, the acknowledgement module 1610 may acknowledge that the user is ready to be handed over from the long term evolution network to the evolved high rate packet data network, where the handover notification message carries information that the user is ready to be handed over from the long term evolution network to the evolved high rate packet data network.

The sending module 1620 is configured to, after the acknowledgement module 1610 acknowledges that the user is ready to be handed over from the long term evolution network to the evolved high speed packet data network, send a buffer instruction message to a serving gateway of the long term evolution network, where the buffer instruction message carries information instructing that the downlink data of the user on the long term evolution network should be buffered.

In an application scenario, after receiving the buffer instruction message sent by an MME, the S-GW begins to buffer the downlink data of the user on the long term evolution network, where the downlink data of the user on the long term evolution network is received from the P-GW.

In an application scenario, the mobility management entity 1600 may an MME or another network entity that has the similar function.

In an application scenario, the mobility management entity 1600 may the MME in the foregoing method embodiments or another network entity that has the similar function.

It can be understood that, a function of each functional module of the mobility management entity 1600 may be specifically implemented according to the methods in the foregoing method embodiments, and for the specific implementation processes, reference may be made to relevant description in the foregoing method embodiments, and details are not repeatedly described here.

For convenience of implementing the technical solutions according to the embodiments of the present invention, an embodiment of the present invention further provides a serving gateway.

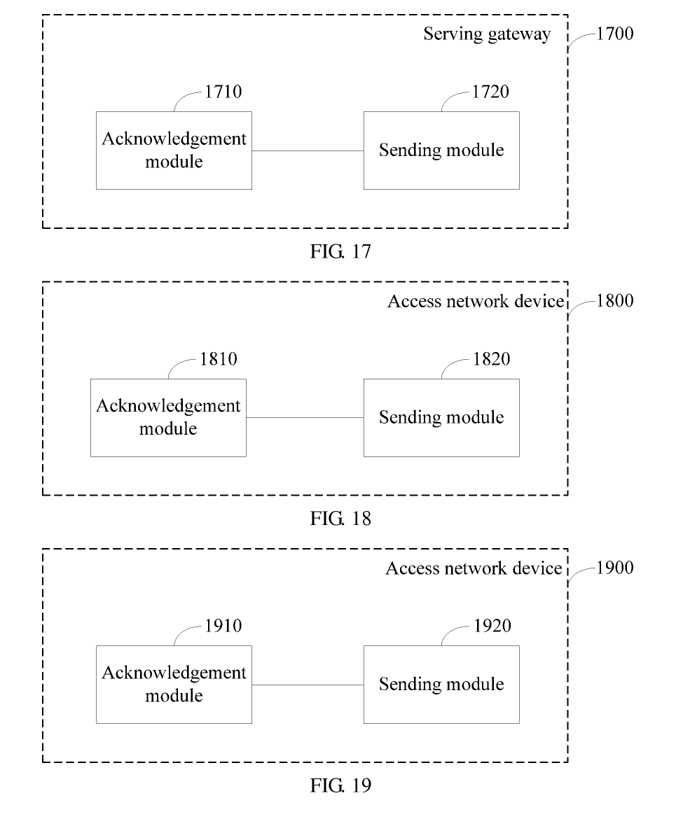

Referring to FIG. 17, a serving gateway 1700 according to a fifteenth embodiment of the present invention may include: an acknowledgement module 1710 and a sending module 1720.

The acknowledgement module 1710 is configured to acknowledge that a user is ready to be handed over from a source network to a target network.

The sending module 1720 is configured to, after the acknowledgement module 1710 acknowledges that the user is ready to be handed over from the source network to the target network, send a buffer instruction message to a data gateway, where the buffer instruction message carries information instructing that downlink data of the user on the source network should be buffered.

In an application scenario, if the source network is an LTE network, the target network is an eHRPD network, and the serving gateway 1700 is specifically an S-GW, the acknowledgement module 1710 may, after receiving a handover notification message sent by a mobility management entity, acknowledge that the user is ready to be handed over from a long term evolution network to an evolved high rate packet data network, where the handover notification message carries information that the user is ready to be handed over from the long term evolution network to the evolved high rate packet data network.

After the acknowledgement module 1710 acknowledges that the user is ready to be handed over from the long term evolution network to the evolved high speed packet data network, the sending module 1720 may send a buffer instruction message to a data gateway, where the buffer instruction message carries information instructing that the downlink data of the user on the long term evolution network should be buffered.

In an application scenario, if the source network is an eHRPD network, the target network is an LTE network, and the serving gateway 1700 is specifically an HSGW, the acknowledgement module 1710 may, after receiving a handover notification message sent by a user equipment or an access network device, acknowledge that the user is ready to be handed over from the evolved high rate packet data network to the long term evolution network, where the handover notification message carries information that the user is ready to be handed over from the evolved high rate packet data network to the long term evolution network.

After the acknowledgement module 1710 acknowledges that the user is ready to be handed over from the evolved high rate packet data network to the long term evolution network, the sending module 1720 may send a buffer instruction message to a data gateway, where the buffer instruction message carries information instructing that the downlink data of the user on the evolved high rate packet data network should be buffered.

In an application scenario, the serving gateway 1700 may be the S-GW, the HSGW in the foregoing method embodiments or another network entity that has the similar function.

It can be understood that, a function of each functional module of the serving gateway 1700 may be specifically implemented according to the methods in the foregoing method embodiments, and for the specific implementation processes, reference may be made to relevant description in the foregoing method embodiments, and details are not repeatedly described here.

For convenience of implementing the technical solutions according to the embodiments of the present invention, an embodiment of the present invention further provides an access network device.

Referring to FIG. 18, an access network device 1800 according to a sixteenth embodiment of the present invention may include: an acknowledgement module 1810 and a sending module 1820.

The acknowledgement module 1810 is configured to acknowledge that a user is ready to be handed over from a source network to a target network.

The sending module 1820 is configured to, after the acknowledgement module 1810 acknowledges that the user is ready to be handed over from the source network to the target network, send a buffer instruction message to a serving gateway of the source network, where the buffer instruction message carries information instructing that downlink data of the user on the source network should be buffered.

In an application scenario, if the source network is an eHRPD network, the target network is an LTE network, and the access network device 1800 is specifically an eAN, the acknowledgement module 1810 may decide that the user equipment executes handover from the eHRPD network to the LTE network if the user meets handover conditions. After receiving the handover notification message sent by the user equipment, the acknowledgement module 1810 may also acknowledge that the user is ready to be handed over from the eHRPD network to the LTE network, where the handover notification message carries information that the user is ready to be handed over from the eHRPD network to the LTE network.

After the acknowledgement module 1810 acknowledges that the user is ready to be handed over from the eHRPD network to the LTE network, the sending module 1820 may send a buffer instruction message to an HSGW, where the buffer instruction message carries information instructing that downlink data of the user on the eHRPD network should be buffered.

After receiving the buffer instruction message, the HSGW may begin to buffer the downlink data of the user on the eHRPD network.

In an application scenario, the access network device 1800 may be the eAN in the foregoing method embodiments or another network entity that has the similar function.

It can be understood that, a function of each functional module of the access network device 1800 may be specifically implemented according to the methods in the foregoing method embodiments, and for the specific implementation processes, reference may be made to relevant description in the foregoing method embodiments, and details are not repeatedly described here.

For convenience of implementing the technical solutions according to the embodiments of the present invention, an embodiment of the present invention further provides an access network device.

Referring to FIG. 19, an access network device 1900 according to a seventeenth embodiment of the present invention may include: an acknowledgement module 1910 and a sending module 1920.

The acknowledgement module 1910 is configured to acknowledge that a user is ready to be handed over from a source network to a target network.

The sending module 1920 is configured to, after the acknowledgement module 1910 acknowledges that the user is ready to be handed over from the source network to the target network, send a handover notification message, where the handover notification message carries information that the user is ready to be handed over from the source network to the target network.

In an application scenario, if the source network is an LTE network, the target network is an eHRPD network, and the access network device 1900 is specifically an eNB, the acknowledgement module 1910 may decide that the user equipment executes handover from the LTE network to the eHRPD network if the user meets handover conditions. After receiving the handover notification message sent by the user equipment, the acknowledgement module 1910 may acknowledge that the user is ready to be handed over from the LTE network to the eHRPD network, where the handover notification message carries information that the user is ready to be handed over from the LTE network to the eHRPD network.

After the acknowledgement module 1910 acknowledges that the user is ready to be handed over from the LTE network to the eHRPD network, the sending module 1920 may send a handover notification message carrying that the user is ready to be handed over from the LTE network to the eHRPD network to the mobility management entity.

After receiving the handover notification message, the mobility management entity may send a buffer instruction message to an S-GW, and instruct the S-GW to begin to buffer the downlink data of the user on the LTE network.

After receiving the handover notification message, the mobility management entity may send a handover notification message to the S-GW to notify the S-GW that the user is ready to be handed over from the LTE network to the eHRPD network. After receiving the handover notification message, the S-GW may send a buffer instruction message to a P-GW and instruct the P-GW to begin to buffer the downlink data of the user on the LTE network.

In an application scenario, the access network device 1900 may be the eNB in the foregoing method embodiments or another network entity that has the similar function.

It can be understood that, a function of each functional module of the access network device 1900 may be specifically implemented according to the methods in the foregoing method embodiments, and for the specific implementation processes, reference may be made to relevant description in the foregoing method embodiments, and details are not repeatedly described here.

For convenience of implementing the technical solutions according to the embodiments of the present invention, an embodiment of the present invention further provides a user equipment.

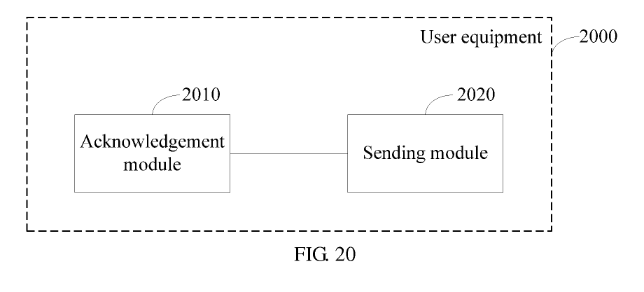

Referring to FIG. 20, a user equipment 2000 according to an eighteenth embodiment of the present invention may include: an acknowledgement module 2010 and a sending module 2020.

The acknowledgement module 2010 is configured to acknowledge that a user is ready to be handed over from a source network to a target network.

The sending module 2020 is configured to, after the acknowledgement module 1810 acknowledges that the user is ready to be handed over from the source network to the target network, send a handover notification message, where the handover notification message carries information that the user is ready to be handed over from the source network to the target network.

In an application scenario, if the source network is an LTE network, and the target network is an eHRPD network, the acknowledgement module 2010 may decide and acknowledge that the user equipment is handed over from the LTE network to the eHRPD network if meeting handover conditions, and begin to execute handover operations.

After the acknowledgement module 2010 acknowledges that the user is ready to be handed over from the LTE network to the eHRPD network, the sending module 2020 may send a handover notification message carrying that the user is ready to be handed over from the LTE network to the eHRPD network to the mobility management entity or the access network device.

After receiving the handover notification message sent by the user equipment, the access network device may send a handover notification message to the mobility management entity, and notify the mobility management entity that the user is ready to be handed over from the LTE network to the eHRPD network.

After receiving the handover notification message sent by the user equipment or the access network device, the mobility management entity may send a buffer instruction message to an S-GW, and instruct the S-GW to begin to buffer the downlink data of the user on the LTE network.

The mobility management entity may, after receiving the handover notification message, send a handover notification message to the S-GW to notify the S-GW that the user is ready to be handed over from the LTE network to the eHRPD network. After receiving the handover notification message, the S-GW may send a buffer instruction message to the P-GW and instruct the P-GW to begin to buffer the downlink data of the user on the LTE network.

In another application scenario, if the source network is an eHRPD network, and the target network is an LTE network, the acknowledgement module 2010 may decide and acknowledge that the user equipment is handed over from the eHRPD network to the LTE network if meeting handover conditions, and begin to execute handover operations.

After the acknowledgement module 2010 acknowledges that the user is ready to be handed over from the eHRPD network to the LTE network, the sending module 2020 may send a handover notification message carrying that the user is ready to be handed over from the eHRPD network to the LTE network to the access network device.

After the acknowledgement module 2010 acknowledges that the user is ready to be handed over from the eHRPD network to the LTE network, the sending module 2020 may send a handover notification message carrying that the user is ready to be handed over from the eHRPD network to the LTE network to an HSGW, and notify the HSGW that the user is ready to be handed over from the eHRPD network to the LTE network.

After receiving the handover notification message sent by the user equipment or the access network device, the HSGW sends a buffer instruction message to the P-GW, and instruct the P-GW to begin to buffer the downlink data of the user on the eHRPD network.

In an application scenario, after the acknowledgement module 2010 acknowledges that the user is ready to be handed over from the eHRPD network to the LTE network, the sending module 2020 may send a message carrying information instructing that it begins to buffer the downlink data of the user on the eHRPD network to the HSGW, and instruct the HSGW to begin to buffer the downlink data of the user on the eHRPD network.

In an application scenario, the user equipment 2000 may be the UE in the foregoing method embodiments or another network entity that has the similar function.

It can be understood that, a function of each functional module of the user equipment 2000 may be specifically implemented according to the methods in the foregoing method embodiments, and for the specific implementation processes, reference may be made to relevant description in the foregoing method embodiments, and details are not repeatedly described here.

It should be noted that, for the foregoing method embodiments, for simple description, the methods are described as a series of action combinations, but persons of ordinary skill in the art should acquire that, the present invention is not limited by the described action sequence, because according to the present invention, some steps may be performed in other orders or performed simultaneously. Next, persons of ordinary skill in the art should also acquire that, the embodiments described in the specification are exemplary embodiments, and involved actions and modules are not indispensable for the present invention.

In the foregoing embodiments, descriptions of the embodiments have different emphases, and for parts that are not described in detail in one embodiment, reference may be made to relevant description of the other embodiments.

In conclusion, in the technical solutions according to the embodiments of the present invention, after the UE is ready to be handed over from the source network to the target network, the downlink data of the UE on the source network is buffered, and the buffered downlink data of the UE on the source network is sent to the target network, so that the UE that is handed over to the target network can obtain the downlink data of the UE on the source network from the target network, thus preventing the UE from losing the downlink data of the UE on the source network.

Further, multiple implementation solutions may be flexibly selected to meet requirements of different application scenarios.

Persons of ordinary skill in the art should understand that all or part of the steps in the methods of the foregoing embodiments may be accomplished through a program instructing relevant hardware. The program may be stored in a computer readable storage medium, where the storage medium may include a read only memory, a random access memory, a magnetic disk or an optical disk.

The handover control method and a device provided by the embodiments of the present invention are described in detail above. The principles and implementation modes of the present invention are described through specific examples. The description of the foregoing embodiments is merely provided for ease of understanding the method and core ideas of the present invention. Persons of ordinary skill in the art can make modifications and variations to the specific implementation modes and application scopes according to the ideas of the present invention. Therefore, the specification shall not be construed as limitations to the present invention.

In the claims:

1. A handover control method, applicable to handover between networks adopting different access technologies, the method comprising:
buffering, by a serving gateway of a source network, downlink data of a user terminal on the source network after the source network determines that the user terminal is ready to be handed over to a target network; and
sending, by the serving gateway of the source network, the downlink data to a serving gateway of the target network after the user terminal is handed over from the source network to the target network.

2. The method according to claim 1, wherein the source network determines that the user terminal is ready to be handed over to the target network by receiving notification from the user terminal or an access network device that the user terminal is ready to be handed over to the target network.

3. The method according to claim 1, wherein sending the downlink data to the serving gateway of the target network comprises:
establishing, by the serving gateway of the source network, a data forwarding tunnel between the serving gateway of the source network and the serving gateway of the target network, and
sending the downlink data to the serving gateway of the target network through the data forwarding tunnel.

4. The method according to claim 3, wherein establishing the data forwarding tunnel between the serving gateway of the source network and the serving gateway of the target network comprises:
obtaining, by the serving gateway of the source network, a tunnel establishment parameter from a data gateway or the serving gateway of the target network, and
establishing the data forwarding tunnel between the serving gateway of the source network and the serving gateway of the target network according to the tunnel establishment parameter.

5. The method according to claim 1, wherein sending the downlink data to the serving gateway of the target network comprises:
establishing, by the serving gateway of the source network, a data forwarding tunnel between the serving gateway of the source network and a data gateway, and
sending the downlink data to the serving gateway of the target network through the data gateway.

6. The method according to claim 1, wherein the source network is a long term evolution network and the target network is an evolved high rate packet data network.

7. The method according to claim 1, wherein the source network is an evolved high rate packet data network and the target network is a long term evolution network.

8. A handover control method, applicable to handover between networks adopting different access technologies, the method comprising:
after receiving a notification for buffering data, wherein the notification for buffering data is from a source network, buffering, by a data gateway, downlink data of a user terminal on the source network; and
after the user terminal is handed over from the source network to a target network, sending, by the data gateway, the buffered downlink data to a serving gateway of the target network.

9. The method according to claim 8, wherein the method comprises:
acquiring, by the source network, that the user terminal is ready to be handed over to the target network and sending the notification for buffering data to the data gateway.

10. A gateway, comprising:
a buffering module, configured to buffer downlink data of a user terminal on a source network, after acquiring that the user terminal is ready to be handed over to a target network; and
a sending module, configured to send the downlink data buffered by the buffering module to a serving gateway of the target network after the user terminal is handed over from the source network to the target network.

11. The gateway according to claim 10, wherein the sending module comprises:
a first tunnel establishment sub-module, configured to establish a data forwarding tunnel with the serving gateway of the target network; and
a first sending sub-module, configured to send downlink data buffered by the buffering module to the serving gateway of the target network through the data forwarding tunnel established by the first tunnel establishment sub-module.

12. The gateway according to claim 11, wherein the first tunnel establishment sub-module is configured to obtain a tunnel establishment parameter from a data gateway or the serving gateway of the target network, and to establish the data forwarding tunnel with the serving gateway of the target network according to the tunnel establishment parameter.

13. The gateway according to claim 10, wherein the sending module comprises:
a second tunnel establishment sub-module, configured to establish a data forwarding tunnel with a data gateway; and
a second sending sub-module, configured to send the downlink data buffered by the buffering module to the serving gateway of the target network through the data gateway.

14. (canceled)

15. The gateway according to claim 10, wherein the gateway comprises a serving gateway.

16. The gateway according to claim 10, wherein the gateway comprises a data gateway.

17. A handover control method, applicable to handover between networks adopting different access technologies, the method comprising:
acquiring, by a source network, that a user terminal is ready to be handed over to a target network;
buffering, by a serving gateway of the source network, downlink data of a user terminal on the source network after the source network acquires that the user terminal is ready to be handed over to a target network;
handing the user terminal over from the source network to the target network; and
sending, by the serving gateway of the source network, the downlink data to a serving gateway of the target network after the user terminal is handed over from the source network to the target network.

18. The method according to claim 17, wherein acquiring that the user terminal is ready to be handed over to the target network comprises receiving notification from the user terminal or an access network device that the user terminal is ready to be handed over to the target network.

19. The method according to claim 17, wherein sending the downlink data to the serving gateway of the target network comprises:
establishing, by the serving gateway of the source network, a data forwarding tunnel between the serving gateway of the source network and the serving gateway of the target network; and
sending the downlink data to the serving gateway of the target network through the data forwarding tunnel.

20. The method according to claim 19, wherein establishing the data forwarding tunnel comprises:
obtaining, by the serving gateway of the source network, a tunnel establishment parameter from a data gateway or the serving gateway of the target network; and
establishing the data forwarding tunnel between the serving gateway of the source network and the serving gateway of the target network according to the tunnel establishment parameter.

21. The method according to claim 17, wherein sending the downlink data to the serving gateway of the target network comprises:
establishing, by the serving gateway of the source network, a data forwarding tunnel between the serving gateway of the source network and a data gateway; and
sending the downlink data to the serving gateway of the target network through the data gateway.
